(19) United States
(12) Patent Application Publication
(10) Pub. No.: US 2021/0174410 A1
(43) Pub. Date: Jun. 10, 2021

(54) RAIL ASSET MANAGEMENT SYSTEM AND INTERACTIVE USER INTERFACE

(71) Applicant: Koch Rail, LLC, Wichita, KS (US)

(72) Inventors: Ashley Anderson, Wichita, KS (US); Tammy Gillespie, Wichita, KS (US); Aaron Hoerst, Wichita, KS (US); Stefani Katz, Wichita, KS (US); Eric Monger, Wichita, KS (US); Dustan Smith, Wichita, KS (US); Christopher Stopczynski, Wichita, KS (US); Nathan Ternes, Wichita, KS (US); Jennifer Walker, Wichita, KS (US)

(21) Appl. No.: 17/115,113

(22) Filed: Dec. 8, 2020

Related U.S. Application Data
(60) Provisional application No. 62/945,235, filed on Dec. 9, 2019.

(51) Int. Cl. G06Q 30/04; G06Q 10/00; G06Q 10/10; G06Q 30/06; G06Q 50/26; G06F 16/23; G06F 9/54; G06F 3/0483; B61L 25/04; B61L 27/00

(52) U.S. Cl. CPC G06Q 30/04; G06Q 10/20; G06Q 10/10; G06Q 30/0645; B61L 27/0094; G06F 16/2379; G06F 9/541; G06F 3/0483; B61L 25/04; G06Q 50/26

(57) ABSTRACT

Various embodiments provide methods, systems, apparatus, computer program products, and/or the like configured to filter received information/data/documents into appropriate storage locations for computationally efficient and reduced latency provision of an interactive user interface (IUI). For example, computer program code stored in a memory of an apparatus may be configured to, when executed by a processor of the apparatus, cause the apparatus to receive an electronic communication comprising information corresponding to a rail asset; determine an asset identifier configured to identify the rail asset based at least in part on content of the electronic communication; determine a category corresponding to the information based at least in part on content of the electronic communication; identify, based at least in part on the category, a database; generate/update a database record stored in the database based at least in part on the information and associated with the asset identifier; and provide an IUI configured to enable user interaction with the generated or updated database record.

### CROSS-REFERENCE TO RELATED APPLICATIONS

This application claims priority to U.S. Application No. 62/945,235 filed Dec. 9, 2019, the content of which is incorporated herein by reference in its entirety.

### FIELD

Various embodiments relate generally to rail asset management (AM) and interactive user interfaces (IUI) for allowing users to leverage the functionality of the rail AM. For instance, an example embodiment relates to a rail AM system for tracking and maintaining information/data corresponding to a plurality of rail assets, including mechanical integrity, distance (e.g., mileage, kilometer age) history, service history, inspection history, and/or the like.

### BACKGROUND

Rail assets, such as railcars, come in a variety of different types (e.g., tank car, boxcar, gondola, open hopper, covered hopper, flat car, and/or the like). Various types of rail assets have different regulations governing their qualifications and uses. Additionally, various types of rail assets are subject to different maintenance schedules. An owner or lessee may find it difficult to track the necessary information/data for ensuring that each rail asset owned by the owner and/or leased by the lessee is in compliance with various regulations and maintenance qualifications. Moreover, when a rail asset is out of service for maintenance, repairs, qualification, inspection, and/or the like while the rail asset is leased, it may be difficult to track the time that the rail asset is unavailable for use by the lessee for accurate invoicing. Through applied effort, ingenuity, and innovation, many of these identified problems have been solved by developing solutions that are included in embodiments of the present disclosure, many examples of which are described in detail herein.

### BRIEF SUMMARY OF SOME EXAMPLE EMBODIMENTS

Various embodiments provide methods, apparatuses, computer program products, systems, and/or the like for providing a rail AM system. In various embodiments, the rail AM system is configured to track structural/mechanical information/data, usage information/data, lease and/or rider information/data, repair/maintenance information/data, compliance information/data, and/or the like corresponding to one or more rail assets; generate invoices corresponding to leases or sub-leases of one or more rail assets; and/or the like. In various embodiments, the rail AM system provides a rail AM IUI via which users may access information/data and/or documents stored and/or generated by the rail AM system, provide information/data and/or documents for storage and/or analysis by the rail AM system, and/or the like.

According to a first aspect, an apparatus is provided. In an example embodiment, the apparatus comprises at least one processor, at least one memory storing computer program code corresponding to a rail asset management system, and a communications interface. The at least one memory and the computer program code are configured to, with the processor, cause the apparatus to perform at least one of store and manage access to documents corresponding to rail assets; store and manage asset profiles regarding rail assets; generate, manage, and store leases and riders corresponding to the rail assets; generate and submit service requests; manage service events; manage compliance events; process and/or generate invoices, including service invoices and/or lease-related invoices, including determining and/or applying adjustments to invoices; provide an interactive user interface to enable user viewing of, interaction with, and/or visibility of the documents, the asset profiles, the service requests, the service events, the compliance events, the invoices, and/or the leases and/or riders; and/or communicate with a user computing entity to receive and provide information/data corresponding to any of the above.

According to another aspect, a method is provided. In an example embodiment, the method comprises performing one or more operations, processes, and/or procedures to provide at least one function of a rail asset management system, such as storing and managing access to documents corresponding to rail assets; storing and managing asset profiles regarding rail assets; generating, managing, and storing leases and riders corresponding to the rail assets; generating and submitting service requests; managing service events; managing compliance events; processing and/or generating invoices, including service invoices and/or lease-related invoices, including determining and/or applying adjustments to invoices; and/or providing an interactive user interface to enable user viewing of, interaction with, and/or visibility of the documents, the asset profiles, the service requests, the service events, the compliance events, the invoices, and/or the leases and/or riders.

According to still another aspect, a computer program product is provided. In an example embodiment, the computer program product comprises at least one non-transitory computer-readable storage medium having computer-executable program code instructions stored therein. The computer-executable program code instructions comprise program code instructions configured to provide at least one function of a rail asset management system, such as storing and managing access to documents corresponding to rail assets; storing and managing asset profiles regarding rail assets; generating, managing, and storing leases and riders corresponding to the rail assets; generating and submitting service requests; managing service events; managing compliance events; processing and/or generating invoices, including service invoices and/or lease-related invoices, including determining and/or applying adjustments to invoices; and/or providing an interactive user interface to enable user viewing of, interaction with, and/or visibility of the documents, the asset profiles, the service requests, the service events, the compliance events, the invoices, and/or the leases and/or riders.

According to an aspect of the present disclosure, an apparatus is provided. In an example embodiment, the apparatus comprises at least one processor, at least one memory storing computer program code corresponding to a rail asset management system, and a communications interface. The at least one memory and the computer program code configured to, with the processor, cause the apparatus to at least receive an electronic communication comprising information corresponding to a rail asset; determine an asset identifier configured to identify the rail asset based at least in part on content of the electronic communication; determine a category corresponding to the information based at least in part on content of the electronic communication; identify, based at least in part on the category, a database corresponding to the information; generate or update a database record stored in the identified database based at least in part on the information and associated with the asset identifier; and provide an interactive user interface (IUI) configured to enable user interaction with the generated or updated database record. The IUI is provided such that display of the IUI is caused via a display.

According to another aspect, a method is provided. In an example embodiment, the method comprises receiving, by one or more processors, an electronic communication comprising information corresponding to a rail asset; determining, by the one or more processors, an asset identifier configured to identify the rail asset based at least in part on content of the electronic communication; determining, by the one or more processors, a category corresponding to the information based at least in part on content of the electronic communication; identify, by the one or more processors and based at least in part on the category, a database corresponding to the information; generating or updating, by the one or more processors, a database record stored in the identified database based at least in part on the information and associated with the asset identifier; and providing, by the one or more processors, an interactive user interface (IUI) configured to enable user interaction with the generated or updated database record, the IUI provided such that display of the IUI is caused via a display.

According to still another aspect, a computer program product is provided. In an example embodiment, the computer program product comprises at least one non-transitory computer-readable storage medium having computer-executable program code instructions stored therein. The computer-executable program code instructions comprise program code instructions configured to, when executed by a processor of an apparatus, cause the apparatus to receive an electronic communication comprising information corresponding to a rail asset; determine an asset identifier configured to identify the rail asset based at least in part on content of the electronic communication; determine a category corresponding to the information based at least in part on content of the electronic communication; identify, based at least in part on the category, a database corresponding to the information; generate or update a database record stored in the identified database based at least in part on the information and associated with the asset identifier; and provide an interactive user interface (IUI) configured to enable user interaction with the generated or updated database record. The IUI is provided such that display of the IUI is caused via a display.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a system that can be used to practice various embodiments of the present invention;

FIG. 2 is a schematic of a server system in accordance with certain embodiments of the present invention;

FIG. 3 is a schematic of a user computing entity in accordance with certain embodiments of the present invention;

FIG. 4A provides an example view of a rail AM interactive user interface (IUI), in accordance with an example embodiment of the present invention;

FIG. 4B is a flowchart illustrating processes, procedures, and/or operations performed by, for example, a server system of FIG. 2, in accordance with an example embodiment;

FIG. 5 is a schematic illustration of a rail asset tracking system, in accordance with an example embodiment of the present invention;

FIGS. 6-20, 22-26, 28-37, and 44-49 provide example views of a rail AM IUI, in accordance with an example embodiment of the present invention;

FIG. 21 provides a schematic illustration of a lease and rider hierarchy, in accordance with an example embodiment of the present invention;

FIG. 27 provides a flow diagram illustrating the flow of information/data used to manage a service event, in accordance with an example embodiment of the present invention;

FIGS. 38-41 together provide flowcharts illustrating processes, procedures, operations, and/or the like for vouchering an invoice, in accordance with an example embodiment of the present invention;

FIG. 42 provides a status evolution diagram for invoices, billing repair cards (BRCs), and BRC lines, in accordance with an example embodiment of the present invention; and

FIG. 43 provides a flowchart illustrating processes, procedures, operations, and/or the like for rail asset service invoice processing, in accordance with an example embodiment of the present invention.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. Brief Overview

Various embodiments provide methods, apparatuses, computer program products, systems, and/or the like for providing a rail AM system. In various embodiments, the rail AM system is configured to track structural/mechanical information/data, usage information/data, lease and/or rider information/data, service (e.g., repair/maintenance) information/data, compliance information/data, and/or the like corresponding to one or more rail assets; generate and/or pay invoices corresponding to leases or sub-leases of one or more rail assets and/or service events; and/or the like. In various embodiments, the rail AM system provides a rail AM IUI via which users may access information/data and/or documents stored and/or generated by the rail AM system; provide information/data and/or documents for storage and/or analysis by the rail AM system; and/or the like.

### II. Computer Program Products, Methods, and Computing Entities

Embodiments of the present invention may be implemented in various ways, including as computer program products that comprise articles of manufacture. Such computer program products may include one or more software components including, for instance, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules/engines, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module/engine (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module/engine (REVIM), dual in-line memory module/engine (DIMM), single in-line memory module/engine (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to step/operation diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For instance, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Exemplary System Architecture

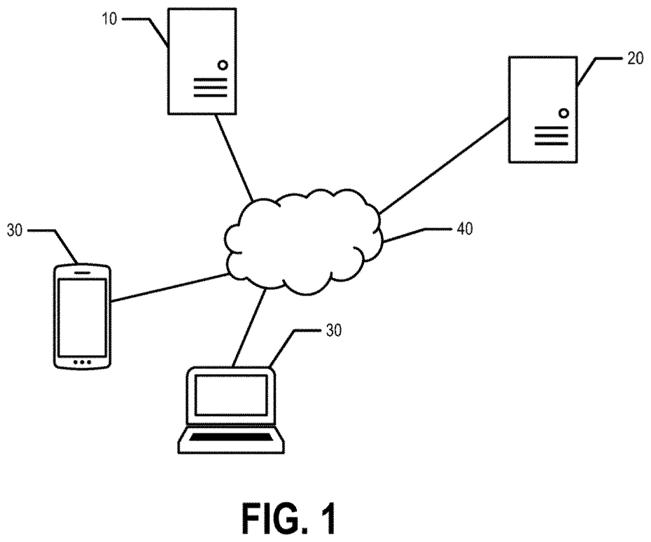

FIG. 1 provides an illustration of a rail AM system that can be used in conjunction with various embodiments of the present invention. As shown in FIG. 1, the rail AM system may comprise one or more server systems 10, one or more external computing entities 20, one or more user computing entities 30, one or more networks 40, and/or the like. Each of the components of the platform may be in electronic communication with, for instance, one another over the same or different wireless or wired networks 40 including, for instance, a wired or wireless Personal Area Network (PAN), Local Area Network (LAN), Metropolitan Area Network (MAN), Wide Area Network (WAN), or the like. Additionally, while FIG. 1 illustrates certain system entities as separate, standalone entities, the various embodiments are not limited to this particular architecture.

### Exemplary Server System

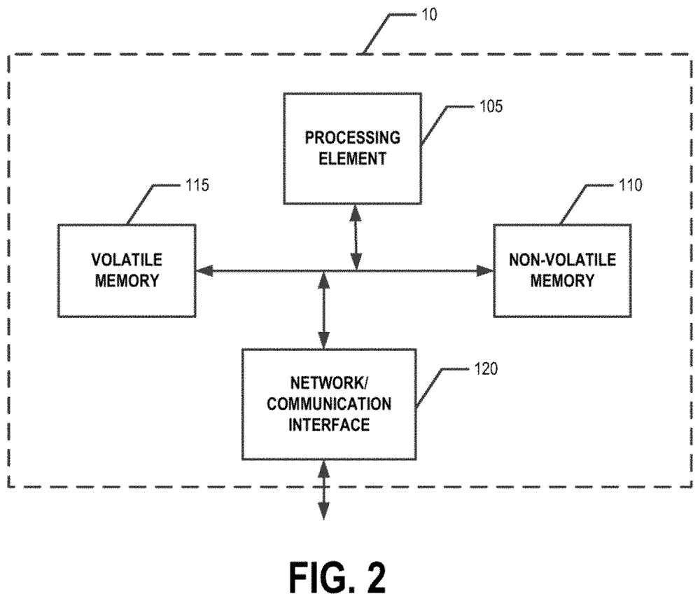

FIG. 2 provides a schematic of a server system 10 according to one embodiment of the present invention. In various embodiments, one or more server systems 10 are operated by and/or on behalf of an individual, organization, company, department of a corporation, and/or the like for providing a rail asset management system and corresponding IUI. In general, the terms computing entity, entity, device, system, and/or similar words used herein interchangeably may refer to, for example, one or more computers, computing entities, desktop computers, mobile phones, tablets, phablets, notebooks, laptops, distributed ledger systems, items/devices, terminals, servers or server networks, blades, gateways, switches, processing devices, processing entities, relays, routers, network access points, base stations, the like, and/or any combination of devices or entities adapted to perform the functions, operations, and/or processes described herein. Such functions, operations, and/or processes may include, for instance, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As shown in FIG. 2, in one embodiment, the server system 10 may include or be in communication with one or more processing elements 105 (also referred to as processors, processing circuitry, and/or similar terms used herein interchangeably) that communicate with other elements within the server system 10 via a bus, for instance. As will be understood, the processing element 105 may be embodied in a number of different ways. For instance, the processing element 105 may be embodied as one or more complex programmable logic devices (CPLDs), microprocessors, multi-core processors, coprocessing entities, application-specific instruction-set processors (ASIPs), and/or controllers. Further, the processing element 105 may be embodied as one or more other processing devices or circuitry. The term circuitry may refer to an entirely hardware embodiment or a combination of hardware and computer program products. Thus, the processing element 105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 105 may be configured for a particular use or configured to execute instructions stored in volatile or non-volatile media or otherwise accessible to the processing element 105. As such, whether configured by hardware or computer program products, or by a combination thereof, the processing element 105 may be capable of performing steps or operations according to embodiments of the present invention when configured accordingly.

In one embodiment, the server system 10 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 110 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules/engines, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the server system 10 may further include or be in communication with volatile media (also referred to as volatile storage, memory, memory storage, memory circuitry and/or similar terms used herein interchangeably). In one embodiment, the volatile storage or memory may also include one or more volatile storage or memory media 115 as described above, such as RAM, DRAM, SRAM, FPM DRAM, EDO DRAM, SDRAM, DDR SDRAM, DDR2 SDRAM, DDR3 SDRAM, RDRAM, RIMM, DEVIM, SIMM, VRAM, cache memory, register memory, and/or the like. As will be recognized, the volatile storage or memory media may be used to store at least portions of the databases, database instances, database management system entities, data, applications, programs, program modules/engines, scripts, source code, object code, byte code, compiled code, interpreted code, machine code, executable instructions, and/or the like being executed by, for instance, the processing element 105. Thus, the databases, database instances, database management system entities, data, applications, programs, program modules/engines, scripts, source code, object code, byte code, compiled code, interpreted code, machine code, executable instructions, and/or the like may be used to control certain aspects of the operation of the server system 10 with the assistance of the processing element 105 and operating system.

As indicated, in one embodiment, the server system 10 may also include one or more network and/or communications interfaces 120 for communicating with various computing entities, such as by communicating data, content, information, and/or similar terms used herein interchangeably that can be transmitted, received, operated on, processed, displayed, stored, and/or the like. For instance, the server system 10 may communicate with other server systems 10, one or more external computing entities 20, one or more user computing entities 30, and/or the like.

As indicated, in one embodiment, the server system 10 may also include one or more network and/or communications interfaces 120 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the server system 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entities may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the server system's 10 components may be located remotely from other server system 10 components, such as in a distributed system. Furthermore, one or more of the components may be combined and additional components performing functions described herein may be included in the server system 10. Thus, the server system 10 can be adapted to accommodate a variety of needs and circumstances.

### Exemplary External Computing Entity

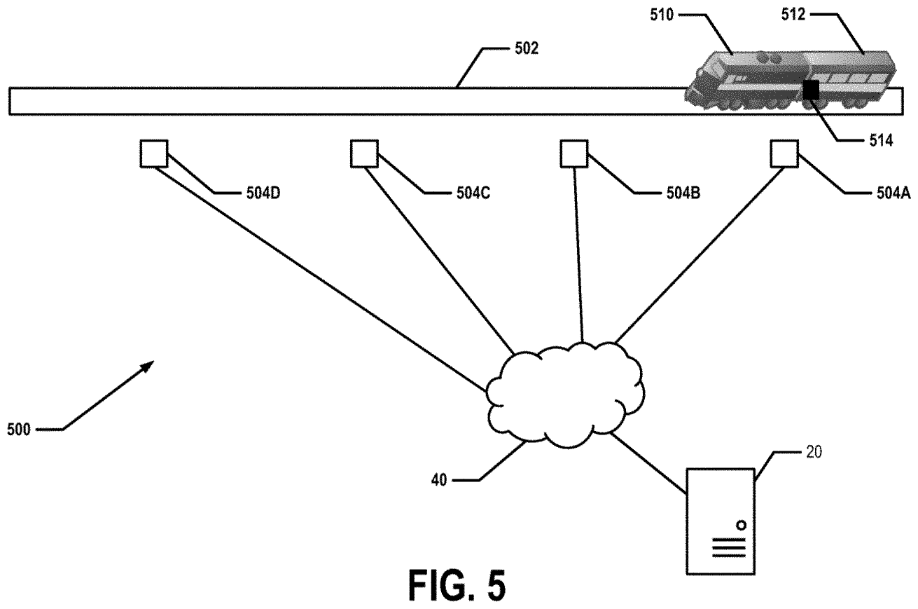

In various embodiments, an external computing entity 20 is a computing entity that is configured to track the location of one or more rail assets along a railway network 500 (See FIG. 5). In various embodiments, a server system 10 may be configured to communicate with one or more external computing entities 20 to receive information/data regarding the current or past location of one or more rail assets along a railway network 500. For example, one or more applications, programs, and/or the like operating on the server system 10 may communicate and/or interface with one or more applications, programs, and/or the like operating on the external computing system 20 through, for instance, respective APIs. In various embodiments, an external computing entity 20 comprises one or more components that are similar to a server system 10 and/or user computing entity 30. For example, an external computing entity 20 may comprise a processing element, volatile and/or non-volatile memory, a network and/or communications interface, and/or the like. In various embodiments, a server system 10 may be configured to perform one or more functions described herein as being performed by an external computing entity 20.

### Exemplary User Computing Entity

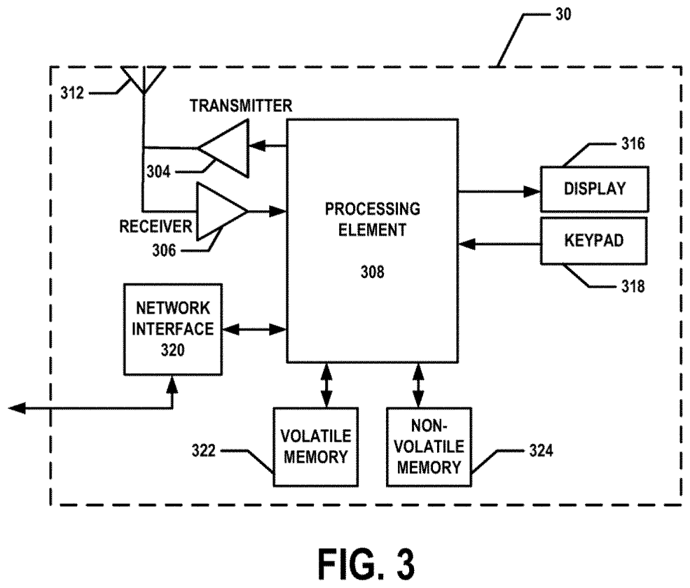

FIG. 3 provides an illustrative schematic representative of a user computing entity 30 that can be used in conjunction with embodiments of the present invention. In various embodiments, a user may be an individual associated with a rail asset owner, rail asset lessee, rail asset sub-lessee, a shop that performs maintenance and/or repairs on one or more rail assets, an inspector that inspects rail assets and/or shops that perform maintenance and/or repairs on rail assets, and/or the like. In various embodiments, a user computing entity 30 is configured to provide an IUI for interaction with by a user for accessing information/data from and/or providing information/data to the rail asset management system. As shown in FIG. 3, a user computing entity 30 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as a server system 10, one or more other user computing entities 30, and/or the like. In this regard, the user computing entity 30 may be capable of operating with one or more air interface standards, communication protocols, modulation types, and access types. More particularly, the user computing entity 30 may operate in accordance with any of a number of wireless communication standards and protocols. In a particular embodiment, the user computing entity 30 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

In various embodiments, the user computing entity 30 may also include one or more network interfaces 320 for communicating with various computing entities, such as by communicating data, content, information, and/or similar terms used herein interchangeably that can be transmitted, received, operated on, processed, displayed, stored, and/or the like. For instance, the user computing entity 30 may communicate with one or more server systems 10, other user computing entities 30, and/or the like.

Via these communication standards and protocols, the user computing entity 30 can communicate with various other entities using concepts, such as Unstructured Supplementary Service information/data (USSD), Short Message Service (SMS), Multimedia Messaging Service (MMS), Dual-Tone Multi-Frequency Signaling (DTMF), and/or Subscriber Identity Module/engine Dialer (SIM dialer). The user computing entity 30 can also download changes, add-ons, and updates, for instance, to its firmware, software (e.g., including executable instructions, applications, program modules/engines), and operating system.

According to one embodiment, the user computing entity 30 may include location determining aspects, devices, modules/engines, functionalities, and/or similar words used herein interchangeably. For instance, the user computing entity 30 may include outdoor positioning aspects, such as a location module/engine adapted to acquire, for instance, latitude, longitude, altitude, geocode, course, direction, heading, speed, UTC, date, and/or various other information/data. In one embodiment, the location module/engine can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the user computing entity's 30 position in connection with a variety of other systems, including cellular towers, Wi-Fi access points, and/or the like. Similarly, the user computing entity 30 may include indoor positioning aspects, such as a location module/engine adapted to acquire, for example, latitude, longitude, altitude, geocode, course, direction, heading, speed, time, date, and/or various other information/data. Some of the indoor aspects may use various position or location technologies including radio frequency identification (RFID) tags, indoor beacons or transmitters, Wi-Fi access points, cellular towers, nearby computing devices (e.g., smartphones, laptops), and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The user computing entity 30 may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For instance, the user output interface may be configured to provide an application, browser, user interface, interface, dashboard, screen, webpage, page, and/or similar words used herein interchangeably executing on and/or accessible via the user computing entity 30 to cause display or audible presentation of information/data and for user interaction therewith via one or more user input interfaces. The user input interface can comprise any of a number of devices allowing the user computing entity 30 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user computing entity 30 and may include a full set of alphabetic keys or set of keys that may be activated to provide a full set of alphanumeric keys. In addition to providing input, the user input interface can be used, for instance, to activate or deactivate certain functions, such as screen savers and/or sleep modes. Through such inputs the user computing entity 30 can collect information/data, user interaction/input, and/or the like.

The user computing entity 30 can also include volatile storage or memory 322 and/or non-volatile storage or memory 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules/engines, scripts, source code, object code, byte code, compiled code, interpreted code, machine code, executable instructions, and/or the like to implement the functions of the user computing entity 30.

In example embodiments, the user computing entity 30 may be in communication with one or more server systems 10 and/or one or more other user computing entities 30. In example embodiments, the user computing entity 30 may be in communication with one or more server systems 10 configured for submitting instances of information/data to and/or accessing instances of information/data from the rail asset management system.

### Exemplary Networks

In one embodiment, any two or more of the illustrative components of the architecture of FIG. 1 may be configured to communicate with one another via respective communicative couplings to one or more networks 40. The networks 40 may include, but are not limited to, any one or a combination of different types of suitable communications networks, such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 40 may have any suitable communication range associated therewith and may include, for instance, global networks (e.g., the Internet), MANs, WANs, LANs, or PANs. In addition, the networks 40 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities.

### IV. Exemplary System Operation

Various embodiments provide a rail AM system with corresponding rail AM IUIs and background functionality. For instance, a user may operate a user computing entity 30 to access a rail AM IUI. For example, a rail AM IUI may be accessed via a dedicated application operating on the user computing entity 30 or via a browser (e.g., web browser) and/or other application operating on the user computing entity 30. For instance, the user may operate the user computing entity 30 to access a portal, intranet, web page, and/or the like via a browser to access the rail AM IUI. In various embodiments, the rail AM IUI may provide a user with information/data corresponding to one or more rail assets (e.g., railcars), provide a user with one or more documents corresponding to one or more rail assets, and/or the like.

In various embodiments, the rail AM IUI may be configured to receive information/data corresponding to rail assets and update one or more information/data records accordingly, receive one or more documents corresponding to one or more rail assets, and/or the like. In an example embodiment, a server system 10 is configured to receive and/or provide information/data and/or documents corresponding to one or more rail assets, maintain records corresponding to one or more rail assets, receive tracking information/data corresponding to one or more rail assets, generate and provide one or more invoices corresponding to rail assets, generate and provide BRC corresponding to rail assets, and/or the like. In an example embodiment, the server system 10 is configured to operate an application and/or program and/or execute computer-executable application program code to provide the rail AM IUI, update and/or maintain one or more datastores (e.g., databases, information/data records, and/or the like) corresponding to the rail AM IUI and/or rail assets, and/or the like.

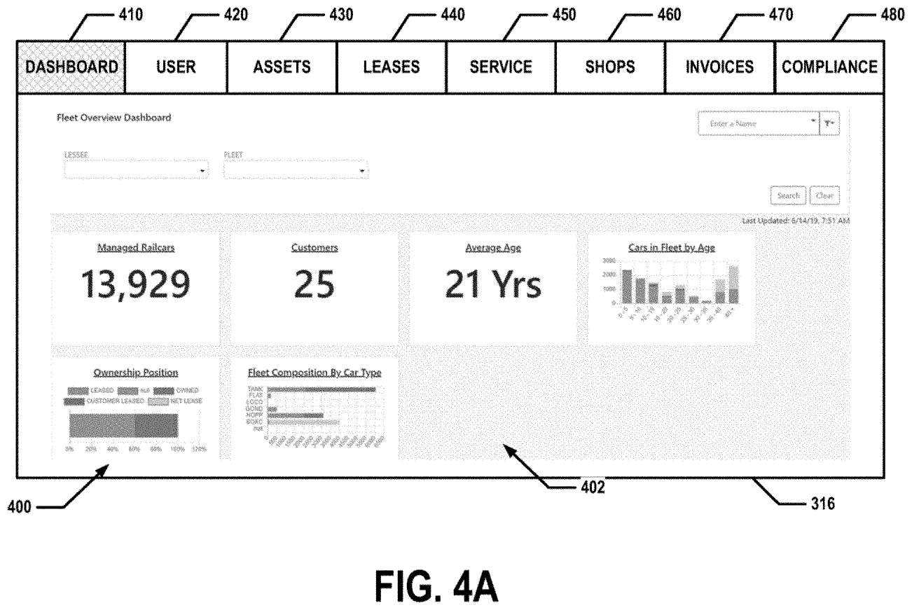

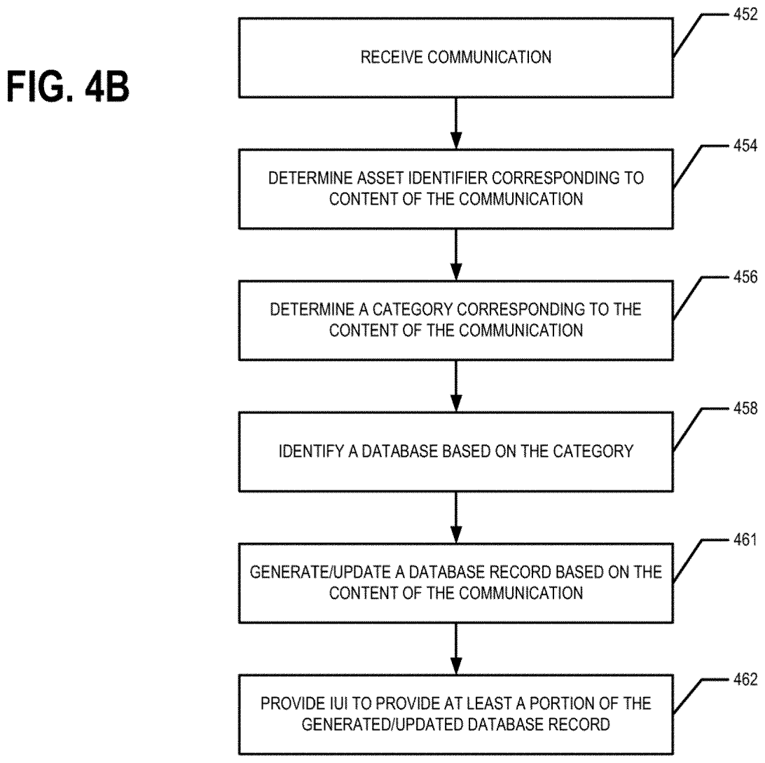

FIG. 4A provides an illustration of an example rail AM IUI 400 that may be provided (e.g., displayed) via a user interface (e.g., display 316) of a user computing entity 30, in an example embodiment. In various embodiments, the rail AM IUI 400 may include a dashboard tab 410 corresponding to landing page 402. In various embodiments, the dashboard tab 410 and/or landing page 402 may provide the user with an overview of a fleet of owned, leased, and/or sub-leased rail assets (e.g., railcars), alerts regarding urgent matters, notifications regarding items that require the user's attention, and/or the like.

In various embodiments, the rail AM IUI 400 may include a user tab 420. In various embodiments, the user tab 420 may provide the user with user information/data from a user profile corresponding to the user; the ability to add, update, change, modify, edit and/or the like user information/data of a user profile corresponding to the user; and/or the like. In an example embodiment, when a user is an administrative user, the user tab 420 may enable the user to manage roles, permissions, and/or the like of one or more other users. In various embodiments, a user may be able to view, update, modify, and/or the like asset information/data corresponding to one or more rail assets; view and/or provide documents corresponding to one or more rail assets based at least in part on the roles, permissions, an entity and/or employer associated with the user; and/or the like indicated by the user information/data of the corresponding user profile (e.g., stored in a user database).

In various embodiments, the rail AM IUI 400 may include an asset tab 430. In various embodiments, the asset tab 430 may enable the user (e.g., operating the user computing entity 30) to search through or filter one or more groups of rail assets, view asset information/data corresponding to one or more rail assets, update and/or modify asset information/data corresponding to one or more rail assets, provide and/or view documents corresponding to one or more rail assets, and/or the like. For example, the asset tab 430 may provide the user with access to and/or to query an asset datastore (e.g., an asset database) storing information/data corresponding to one or more groups of rail assets. In various embodiments, the user is only provided with asset information/data for rail assets that are owned, leased, and/or sub-leased by an entity and/or employer associated with the user (e.g., based at least in part on the user profile corresponding to the user). Further, the rail AM system allows users to bulk upload metadata and documents for multiple rail assets which are related by build specification in groups for much more efficient onboarding of information corresponding to existing rail assets.

In various embodiments, the rail AM IUI 400 may include a lease tab 440. In various embodiments, the lease tab 440 may enable the user (e.g., operating the user computing entity 30) to search through or filter one or more lease data objects storing lease information/data, view lease information/data corresponding to one or more leases, update and/or modify lease information/data corresponding to one or more leases, provide and/or view documents corresponding to one or more leases, and/or the like. In various embodiments, the leases correspond to the leasing/renting of rail assets by an owner of the rail asset to a lessee. In various embodiments, a rail asset may be sub-leased by a lessee to a sub-lessee. In various embodiments, the lease tab 440 may provide the user with access to and/or to query a lease datastore (e.g., a lease database) storing information/data corresponding to one or more leases and/or sub-leases. In various embodiments, the user is only provided with lease information/data for leases where an entity and/or employer associated with the user (e.g., based at least in part on the user profile corresponding to the user) is a party of the lease or sub-lease (e.g., the owner, lessee, or sub-lessee of the lease or sub-lease). In various embodiments, riders associated with leases may be accessed (e.g., in a hierarchical manner), updated and/or modified, and/or the like via the lease tab 440.

In various embodiments, the rail AM IUI 400 may include a service tab 450. In various embodiments, the service tab 450 may enable the user (e.g., operating the user computing entity 30) be provided with information/data regarding service events. The service events may be ongoing services events, expected service events, service programs (e.g., service events corresponding to a plurality of rail assets having the same scope), and/or the like. In an example embodiment, a service event may be a maintenance event, a repair event, a qualification event, an inspection event, and/or the like. In various embodiments, the service tab 450 may enable the user to search through one or more maintenance data objects (e.g., BRCs) storing maintenance information/data corresponding to one or more rail assets; view maintenance information/data corresponding to one or more rail assets and performed by one or more of the shops; update and/or modify maintenance information/data, provide and/or view documents corresponding to one or more maintenance events, and/or the like. In various embodiments, the service tab 450 may provide the user with access to and/or to query a service datastore (e.g., a service database) storing information/data corresponding to one or more service events. In various embodiments, the user is only provided with the service event information/data for rail assets that are owned, leased, and/or sub-leased by the entity and/or employer associated with the user (e.g., based at least in part on the user profile corresponding to the user).

In various embodiments, the rail AM IUI 400 comprises a shop tab 460. As used herein a shop may be an entity, individual, and/or facility that performs maintenance, repairs, safety inspections, qualifications, and/or the like of one or more rail assets. In various embodiments, the shop tab 460 may enable the user (e.g., operating the user computing entity 30) to search through one or more shop data objects storing shop information/data; view shop information/data corresponding to one or more shops; update and/or modify shop information/data, provide and/or view documents corresponding to one or more shops, and/or the like. In various embodiments, the shop tab 460 may provide the user with access to and/or to query a shop datastore (e.g., a shop database) storing information/data corresponding to one or more shops. In various embodiments, the shop information/data may include identifying and/or contact information/data for a shop, one or more services the shop is capable of performing and/or allowed to perform, historical performance information/data for the shop (e.g., length of time required for the shop to perform various services, cost of performing various services, storage costs for rail assets, and/or the like).

In various embodiments, the rail AM IUI 400 comprises an invoice tab 470. In various embodiments, the invoice tab enables a user (e.g., operating a user computing entity 30) to view, pay, manage, and/or generate invoices corresponding to leases and/or riders to which an entity and/or employer associated with the user (e.g., based at least in part on the user profile corresponding to the user) is an owner, lessee, or sub-lessee of the corresponding rail asset(s). In various embodiments, the rail AM may be configured to automatically generate invoices for the lease or sub-lease of one or more rail assets (including rent abatements for time a rail asset was unavailable due to being in a shop and/or the like, in an example embodiment). In various embodiments, the invoice tab 470 may provide the user with the ability to search received invoices, paid invoices, unpaid invoices, and/or the like; accept invoices; reject invoices; and/or the like. In various embodiments, the invoice tab 470 enables a user to search, update, and/or the like an invoice datastore (e.g., invoice database). In various embodiments, a shop may provide an invoice for one or more services performed on a rail asset to the rail asset owner, lessee, or sub-lessee via the invoice tab 470. In an example embodiment, the invoice tab 470 may further provide a user with information/data regarding ad valorem tax due based at least in part on tracking the travel of rail assets through a railway network 500.

In various embodiments, the rail AM IUI 400 comprises a compliance tab 480. In various embodiments, the compliance tab enables a user (e.g., operating a user computing entity 30) to view, manage, and/or the like compliance information/data and/or documents corresponding to one or more rail assets. In an example embodiment, the compliance tab 480 may provide a user with one or more forms and/or regulation information/data corresponding to maintaining compliance of one or more rail assets and/or a fleet of rail assets. In various embodiments, the compliance tab 480 may provide the user with the ability to search compliance information/data for one or more rail assets by querying a compliance database, view compliance information/data and/or compliance documents for one or more rail assets, and/or the like. In an example embodiment, a user may only be provided with access to compliance information/data for rail assets that are owned, leased, and/or sub-leased by an entity and/or employer associated with the user (e.g., based at least in part on the corresponding user profile).

In various embodiments, the user may access the rail AM IUI 400 via a user computing entity 30. For example, a server system 10 may be configured to generate and/or provide the rail AM IUI 400 and/or information/data for populating various features of the rail AM IUI 400 such that a user computing entity 30 receives the rail AM IUI 400 and/or the information/data for populating various features of the rail AM IUI 400 and the user computing entity 30 provides (e.g., displays via display 316), the rail AM IUI 400 accordingly. In various embodiments, a server system 10 may be configured to receive communications from the user computing entity 30 requesting information/data (e.g., user information/data, asset information/data, lease information/data, rider information/data, shop information/data, service information/data, invoice information/data, compliance information/data, and/or the like) and/or documents and access the requested information/data and/or documents from a corresponding data store (e.g., user database, asset database, lease database, shop database, service database, invoice database, compliance database, and/or the like). In various embodiments, the server system 10 may receive information/data and/or documents (e.g., from user computing entities 30 and/or external computing entities 20) and store the received information/data and/or documents in the appropriate data store and/or in association with the appropriate asset identifier. In an example embodiment, one or more of the data stores of the rail AM system is a distributed data store, such as a distributed ledger (e.g., blockchain and/or the like). For instance, the server system 10 may update one or more information/data records based at least in part on received information/data and/or documents. In various embodiments, the server system 10 may analyze received and/or stored information/data and/or documents to provide one or more of statistical analysis of a fleet of rail assets, expected service (e.g., maintenance, requalification, and/or the like) events for one or more rail assets, expected compliance events for one or more rail assets, generate invoices corresponding to the lease or sub-lease of one or more rail assets, and/or the like. Various features of the rail AM IUI 400 and corresponding background functionality will now be described in more detail.

In various embodiments, a user may interact with the rail AM IUI 400 provided via a user interface of a user computing entity 30. For example, a user may interact with one or more user input devices/interfaces to provide user input that is received and/or registered by the user computing entity 30. In various embodiments, indications of the user input received and/or registered by the user computing entity 30 is provided (e.g., transmitted) by the user computing entity 30 such that a server system 10 receives the indications of the user input received and/or registered by the user computing entity 30. The server system 10 may analyze the indications of the user input, identify information/data and/or documents to be provided and/or stored/updated/modified based at least in part on the indications of the user input, and, if the server system 10 determines that the user profile corresponding to the user has the appropriate permissions, may perform the corresponding operation(s). For instance, the server system 10 may provide (e.g., transmit) the requested information/data and/or documents such that the user computing entity 30 receives the requested information/data and/or documents and causes at least a portion of the requested information/data and/or documents to be provide via the rail AM IUI 400.

FIG. 4B provides a flowchart illustrating various processes, procedures, operations, and/or the like that may be performed by a server system 10, in various embodiments to perform and/or assist with rail asset management and/or to provide a rail AM IUI 400. For example, the server system 10 may configured to filter information/data and/or documents from received communications into appropriate storage locations (e.g., databases, sub-databases, database portions, and/or the like) to enable a more efficient provision (e.g., requiring less computational resources and having less latency) of an IUI such as the rail AM IUI 400.

Starting at step/operation 452, a communication is received. For example, the server system 10 may receive a communication (e.g., via network/communication interface 120 such that the electronic communication is received by the processing element 105). In various embodiments, the electronic communication comprises information/data corresponding to one or more rail assets. For example, the electronic communication may have been generated and provided by an external computing entity 20, a user computing entity 30, and/or the like. In various embodiments, the information/data may be travel information/data, asset profile information/data, a BCR, inspection information/data, service event information/data, lease and/or rider information/data, invoice information/data, compliance information/data, compliance documents, structural information/data (e.g., parts used to build and/or repair the rail asset, drawings and/or specifications for the rail asset, and/or the like), and/or other information/data corresponding to a rail asset.

At step/operation 454, an asset identifier corresponding to the content of the electronic communication is determined and/or identified. For example, the server system 10 may determine (e.g., using processing element 105, one or more databases stored in memory 110, 115, and/or the like) an asset identifier for each of the one or more rail assets for which information/data is provided in the electronic communication. In an example embodiment, asset identifier is an identifier configured to uniquely identify the corresponding rail asset, at least in the rail AM system, throughout the lifetime of the rail asset (e.g., independent of the mark physically affixed to the rail asset changing). In an example embodiment, the electronic communication comprises the asset identifier for at least one rail asset for which information/data corresponding thereto is provided in the electronic communication. In an example embodiment, a mark or other identifying information corresponding to at least one rail asset for which information/data corresponding thereto is provided in the electronic communication is provided in the electronic communication and can be used to determine and/or identify an asset identifier.

At step/operation 456, a category corresponding to the content of the electronic communication is determined. For example, the server system 10 may determine (e.g., via processing element 105) a category for which the information/data corresponding to the rail asset identified by the identified asset identifier pertains. In an example embodiment, some possible categories include asset information/data, lease and/or rider information/data, service information/data, invoice information/data, compliance information/data, and/or the like. For example, tabs of the rail AM IUI 400 may each correspond to different categories, in an example embodiment. In various embodiments, the category corresponding to the content of the electronic communication is determined based at least in part on metadata associated with the content and/or based at least in part on analyzing the content itself.

At step/operation 458, a database or portion of a database is identified based at least in part on the determined category. For example, each category may corresponding to a database, a sub-database, and/or a database portion of the rail asset management system. The server system 10 may identify and/or determine (e.g., using the processing element 105 and/or information regarding the database(s) stored in the memory 110, 115) which database, sub-database, and/or database portion the content of the electronic communication pertains based at least in part on the identified category.

At step/operation 461, a database record may be generated and/or updated based at least in part on the content of the electronic communication and stored in the identified database, sub-database, and/or database portion. For example, if a database record corresponding to the content of the electronic communication already exists in the identified database, sub-database, and/or database portion, the database record may be updated based at least in part on the content of the electronic communication. For example, if a database record corresponding to the content of the electronic communication does not already exist in the identified database, sub-database, and/or database portion, a data record comprising information/data from the content of the electronic communication may be generated. The generated database record may then be stored in the identified database, sub-database, and/or database portion. In various embodiments, the database record comprises and/or is stored in association with the asset identifier.

At step/operation 462, an interactive user interface (IUI), such as the rail AM IUI 400 is provided. For example, the server system 10 may be configured to provide the rail AM IUI 400 such that a user may view and/or interact with the rail AM IUI 400 via a user computing entity 30 (e.g., via input/output devices thereof). In various embodiments, the provided IUI is configured to enable user interaction with the generated or updated database record. For example, the provided IUI may enable a user to view at least a portion of the information/data stored in the generated or updated database record and/or information/data determined by analyzing and/or processing the information/data stored in the generated or updated database record.

Various screens, views, tabs, and/or functionality provided by the rail AM IUI 400 will now be described. As should be understood by one of skill in the art, the information/data displayed via the rail AM IUI 400, the functionality provided through the rail AM IUI 400, and the technical advantages provided thereby are at least in part enabled by the processes, procedures, and/or operations depicted in FIG. 4B.

### Exemplary User Tab/User Profile Management

In an example embodiment, as indicated, a user may access and/or utilize various features of the rail AM (e.g., via a rail AM IUI 400). In various embodiments, the user tab 420 enables a user to register a user (e.g., the user may register themselves or another user) and/or an entity and/or employer (e.g., associated with and/or employing the user). In various embodiments, registering a user may cause a user profile corresponding to the user to be generated and stored in the user database. In various embodiments, the user tab 420 may further allow the user to update and/or modify a user profile corresponding to the user and/or, if the user has appropriate administrative permissions, update and/or modify one or more other user profiles (e.g., stored in the user database) and/or the associated entity profile (e.g., stored in an entity database).

In order to access and/or utilize the various features of the rail AM, the user may be required to register. For example, registration of a user may cause a corresponding user profile to be generated and stored (e.g., in a user database stored by and/or accessible to a server system 10). For instance, a user (e.g., operating a user computing entity 30) may provide user information/data. For example, a user may use the keypad 318 and/or other input device of the user computing entity 30 to provide user input to enter and/or select user information/data corresponding to the user and an associated entity and/or employer. In various embodiments, the user computing entity 30 may provide (e.g., transmit) the entered and/or selected user information/data to the server system 10. In various embodiments, registration of the user causes a corresponding user profile to be generated and stored in a corresponding data store (e.g., in the user database). In various embodiments, the registration process may include automatically vetting the user and/or an entity and/or employer associated with the user to ensure that the entity and/or employer is legitimate business entity, that the user is associated with (e.g., employed by) the entity and/or employer, that the entity and/or employer is the owner of one or more rail assets, a lessee of one or more rail assets, a sub-lessee of one or more rail assets, an inspector of one or more rail assets, and/or shop configured to perform maintenance, repairs, qualifications, inspections, and/or the like of one or more rail assets.

In various embodiments, a user may operate a user computing entity 30 to access a registration IUI (e.g., via the rail AM IUI 400). For instance, the user computing entity 30 (e.g., using processing element 308) may execute application program code, computer executable code, and/or the like to provide a registration IUI through the rail AM IUI 400. For instance, a user client (e.g., operating on the user computing entity 30 and/or the server system 10) may cause the rail AM IUI 400 to provide a registration IUI via a user interface of the user computing entity 30. In various embodiments, the rail AM IUI 400 may be a dedicated application, a dashboard, a portal, and/or the like accessed via a browser (e.g., a web browser), an app, and/or the like. The registration IUI may comprise a number of fields and/or selectable elements that the user may interact with (e.g., via the user input interface(s) of the user computing entity 30) to insert, provide, and/or select user profile information/data corresponding to the user and/or the entity and/or employer associated with the user (e.g., if the entity and/or employer has not yet been registered). For example, the user profile information/data may include identifying information/data and/or contact information/data for the user and/or an entity and/or employer associated with the user, such as a user name, entity name, an entity mailing address, user telephone number, entity telephone number, user email address, entity email address, and/or other information/data that may be used to identify and/or contact the user and/or the entity and/or employer associated with the user. In various embodiments, the user may provide information/data identifying an entity account that may be automatically credited with payment of rent for the lease or sub-lease of one or more rail assets and/or debited with payment of rent for the lease or sub-lease of one or more rail assets; payment for repairs, maintenance, qualifications, inspections, and/or the like of one or more rail assets; and/or the like. In various embodiments, after the user has entered, provided, and/or selected the user profile information/data, the user profile information/data is provided to the server system 10 and stored in the user database. For instance, if a user profile does not yet exist for the user in the profile database, a new user profile may be generated based at least in part on the user entered, provided, and/or selected user profile information/data and the generated user profile may be stored in the user database. In an example embodiment, if an entity profile does not yet exist for the entity and/or employer associated with the user in the entity database, a new entity profile may be generated based at least in part on the user entered, provided, and/or selected entity profile information/data and the generated entity profile may be stored in the entity database. If a user profile and/or entity profile does already exist in the user database and/or entity database, the existing user profile and/or entity profile may be updated based at least in part on the user entered, provided, and/or selected user profile and/or entity profile information/data.

In various embodiments, a user profile is associated with, assigned, and/or the like permissions that control what information/data is provided to the user (e.g., via the rail AM IUI 400). In various embodiments, the permissions may be role-related, correspond to an entity and/or employer associated with the user, and/or the like. For example, a user may only be provided with information/data regarding rail assets that are owned or leased by an entity and/or employer associated with the user. For example, a user who has the role of loading or unloading a rail asset may have permissions to access some documents regarding the layout of the rail asset, but may not be provided with access to detailed manufacturing and/or fabrication diagrams for the rail asset. However, a user associated with a shop performing a service on the rail asset may be provided with the detailed manufacturing and/or fabrication diagrams for the rail asset. Thus, the user may be provided with information/data for fulfilling the user's role and may not be provided with information/data that is not necessary for fulfilling the user's role. In an example embodiment, a user with appropriate permissions can add new fields to the asset profile template used to generate asset profiles, and/or the like.

### Exemplary Asset Tab/Asset Profile Management

In various embodiments, a rail asset (e.g., a railcar) may be associated with an asset profile stored in an asset database (e.g., stored by and/or accessible to the server system 10). In various embodiments, the asset tab 430 enables a user to access and/or update asset information/data corresponding to one or more rail assets. For example, a user profile corresponding to the user may be associated with an entity and/or employer (e.g., include an entity and/or employer field populated with an entity and/or employer identifier) and the user may be able to view and update (if the corresponding user profile has the appropriate permissions) asset information/data of one or more asset profiles that correspond to rail assets owned, leased, or sub-leased by the associated entity and/or employer. In various embodiments, an asset profile may include asset information/data and/or pointers to one or more documents corresponding to the mechanical integrity of the rail asset, location of the rail asset, compliance information/data corresponding to the rail asset, distance (e.g., mileage, kilometrage) traveled by the rail asset (e.g., a virtual odometer), lease management, vendor management, reporting, service events (e.g., repair and/or maintenance events), and/or the like. The various fields for rail assets (and/or other aspects) are fully customizable to allow system administrators (e.g., permissioned users) to add various fields (e.g., mechanical integrity fields) with QA review rather than writing new code. This can be performed in real-time or after a QA review period (e.g., 24-48 hours).

In various embodiments, the asset profile corresponding to a rail asset comprises asset information/data and/or documents corresponding to the rail asset. In various embodiments, an asset profile is indexed by an asset identifier configured to identify a particular rail asset (e.g., a particular railcar). In various embodiments, the asset profile may further include the current and/or previous asset mark/number (e.g., the mark/number currently and/or previously physically painted on the rail asset). In various embodiments, an asset profile for a rail asset includes an equipment group/type identifier configured to identify the equipment group/type corresponding to the rail asset. In an example embodiment, the equipment group/type corresponds to the type of rail asset (e.g., tank car, boxcar, gondola, open hopper, covered hopper, flat car, and/or the like). In various embodiments, the asset profile may include documents corresponding to the manufacture and/or fabrication of the rail asset. For instance, the asset profile may include documents, such as a specification sheet, drawings, gauge tables, Certificate of Construction, a specialty list, and/or the like corresponding to the manufacture and/or fabrication of the rail asset. In an example embodiment, the documents may be associated with metadata comprising a Certificate of Construction number, builder lot code, asset mark/number, asset identifier, version number, and/or the like. In an example embodiment, the asset profile may comprise multiple versions of a document corresponding to the rail asset. For example, in an example embodiment, an asset profile may store up to the five most recent versions of a document corresponding to the rail asset. In various embodiments, asset profiles for new rail assets may be generated in a batch processing manner. For instance, if a plurality of rail assets were built using the same or similar specifications, the plurality of rail assets may be added to the rail AM system (e.g., have asset profiles generated therefore) in a batch processing manner. The batch processing generated asset profiles may then be individually edited, modified, updated, and/or the like to record any differences between the plurality of rail assets. For example, information/data identifying various components (e.g., component type, part number, make, model, lot, serial number, and/or the like) used in the original fabrication and/or added to the rail asset during a service event may be logged in the asset profile. In various embodiments, the use of a permanent asset identifier (e.g., compared to asset marks/numbers which may change during the life of the rail asset), knowledge of rail asset construction/fabrication details, knowledge of changes made to the rail asset allow rail asset owners, lessees, and/or sub-lessees easily identify whether a particular recall corresponds to a particular rail asset and/or part/component of the particular rail asset. Further, because rail assets can change mark/number at time of sale, the rail AM system associates all information/data to a permanent asset identifier (e.g., regardless and/or independent of the mark/number physically marked on the rail asset) providing a comprehensive asset record. Thus, the rail AM system stores and can provide a historical lineage of a rail asset's mark/number, as well as future marks for planned remarking projects.

In various embodiments, the asset profile may comprise service records for the rail asset storing information/data regarding service events corresponding to the rail asset. In various embodiments, the service events may include repairs, maintenance, and/or specialization/customization/refabrication of the rail asset. In an example embodiment, the service records provide information/data regarding service events for the entire life of the rail asset (e.g., from the time the rail asset was manufactured and/or fabricated to the current time). For example, the asset profile may comprise one or more BRCs corresponding to one or more service events. In various embodiments, the asset profile for a rail asset may comprise multiple versions of a BRC for a particular service event.

In various embodiments, the asset profile may comprise compliance information/data corresponding to the rail asset. For instance, the asset profile may include inspection records, inspection certificates, qualification test records, and/or the like. In an example embodiment, the asset profile may further include information/data regarding upcoming inspections (e.g., when the rail asset is due for inspection, and/or the like).

In various embodiments, the asset profile may include an ownership and/or rent history for the rail asset. For example, for the asset profile may include asset information/data indicating purchase dates and sale dates (if applicable) corresponding to the current and/or previous owner(s) of the rail asset and may include information/data identifying each owner. The asset profile may also include an asset mark/number corresponding to a particular owner and/or time period. For instance, the asset profile may include asset information/data including a rent start date, rent end date, and/or rent amounts (e.g., gross, net) corresponding to a current and/or previous lessee and/or sub-lessee and may include information/data identifying the lessee and/or sub-lessee. In one embodiment, the rail AM system may use single sign-on permissions to only allow users to view contracts, view rail asset information/data, and/or access rent history months for which they (e.g., an entity and/or employer associated with the user as indicated by the corresponding user profile) are associated. As will be recognized, this visibility is customizable. In various embodiments, an owner, lessee, and/or sub-lessee may own/operate multiple fleets of rail assets. In an example embodiment, an asset profile may include a fleet identifier corresponding to the fleet that the rail asset is operated as part of. In an example embodiment, a rail asset is associated with an asset management type indicating whether the rail asset is operated by the owner, leased, sub-leased, and/or the like.

In various embodiments, the asset profile may include tracking information/data for the rail asset. For example, a server system 10 may communicate with an external computing entity 20 to request and receive updates regarding the movement of the rail asset. For instance, the external computing entity 20 may be in communication with a railway network 500, as shown in FIG. 5. In an example embodiment, the railway network 500 comprises a network of railway tracks 502 and plurality of sensors 504A-504D positioned along the railway tracks 502. For example, the sensors 504A-504D may be positioned at set intervals along the railway tracks 502 (e.g., one sensor 504A-504D every mile, every five miles, every ten miles, every twenty miles, and/or the like); near junctions/switches and near yards, garages, shops, and/or other destinations; and/or the like. For instance, a train 510 may comprise one or more rail assets 512, with each rail asset 512 comprising an identifier provider 514. For example, the identifier provider 514 may be an RFID tag secured to the rail asset 512 and the sensors 504A-504D may be RFID readers. In another example, the identifier provider 514 may be an optical code (e.g., bar code, QR code, alphanumeric code, and/or the like) affixed to the rail asset 512 and the sensors 504A-504D may be optical sensors. In another example, the identifier provider 514 and the sensors 504A-504D may communicate via Bluetooth, near-field communication (NFC) protocol, and/or the like.

In various embodiments, as the train 510 travels along the railway track 502, the train 510 passes one or more sensors 504A-504D. As the train 510 passes a sensor 504A-504D, the sensor 504A-504D communicates with the identifier provider 514 and determines the identity of the one or more rail assets 512 of the train 510. The sensors 504A-504D may be in communication with an external computing entity 20 via one or more wired and/or wireless networks 40. For instance, a sensor 504A-504D may be configured to, when train 510 passes the sensor 504A-504D, communicate with the identifier provider 514 of the rail asset 512, determine the identity of the rail asset 512 based at least in part on the electronic communication with the identifier provider 514, and provide a communication comprising the identity of the rail asset 512 (e.g., the asset identifier) and at least one of a sensor identifier and/or a sensor location such that an external computing entity 20 receives the electronic communication. In this manner the external computing entity 20 may track travel information/data for the rail asset 512. In an example embodiment, the travel information/data comprises the current location of the rail asset 512 and the number of miles traveled by the rail asset 512, and the location of the miles traveled by the rail asset 512.

In various embodiments, the server system 10 may be configured to request updates to the travel information/data for a rail asset. For example, the server system 10 may request updates to the travel information/data for a rail asset on a periodic basis (e.g., once a day, once a week, twice a month, once a month, and/or the like), when a user requests to access asset information/data corresponding to the rail asset, and/or the like. The asset information/data for the rail asset may then be updated based at least in part on the received travel information/data updates provided by the external computing entity 20. For example, the travel information/data may be used to approximate fatigue life distance (e.g., mileage, kilometrage) of various components of the rail asset. In an example embodiment, the external computing entity 20 may be an Umler and/or Railinc. computing entity. In an example embodiment, the travel information/data updates may be accompanied by other asset information/data and/or metadata corresponding to the rail asset (e.g., provided by the external computing entity 20). This may an exception-based approach in which the server system 10 queries the external computing entity 20 to request, pull, or receive only information/data that has changed since the last update. This only returns records containing updated information/data. Both the transactional cost (e.g., bandwidth and processing) and the actual cost (e.g., fee paid) are significantly reduced and can be executed as frequently as desired. In other words, the number of executions does not change amount of records returned since only what is required is provided and paid for. In an example embodiment, a user corresponding to a user profile having appropriate permissions may overwrite (e.g., in the asset profile) one or more fields of the asset information/data and/or metadata corresponding to the rail asset received alongside the travel information/data updates. In various embodiments, if a user has provided input (e.g., via a user input device/interface of the user computing entity 30) overwriting one or more fields of the asset information/data and/or metadata corresponding to the rail asset received alongside the travel information/data updates, then the next time travel information/data updates and the accompanying asset information/data and/or metadata corresponding to the rail asset are received, the user overwritten fields will not be updated based at least in part on the asset information/data and/or metadata received from the external computing entity 20. For instance, if the received asset information/data and/or metadata includes a particular field that is populated with “null,” a user may update the particular field to a particular value.

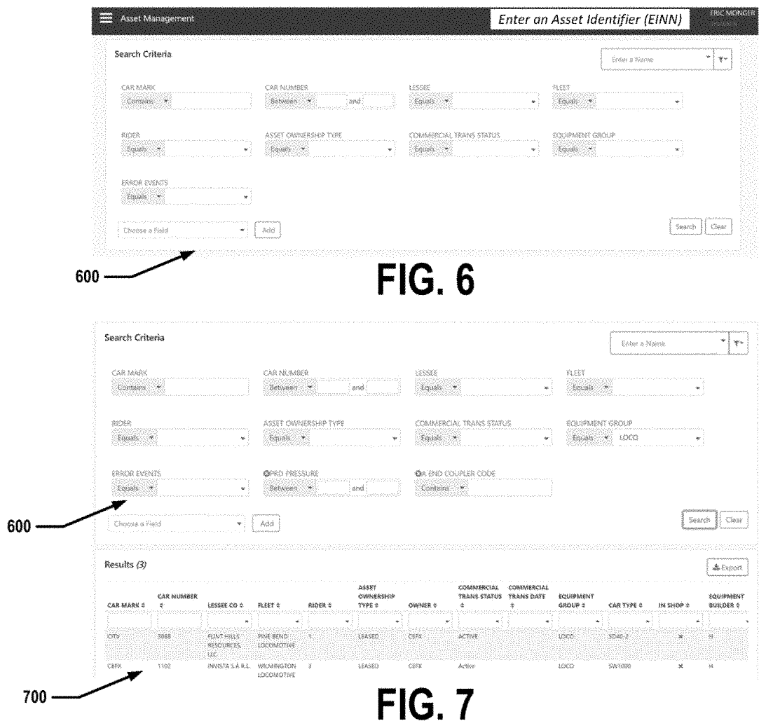

FIG. 6 provides an example view of an equipment or rail asset search 600 provided via an asset tab 430 of the rail AM IUI 400. For example, a user (e.g., operating a user computing entity 30) may search for rail assets by querying the asset database based at least in part on one or more of asset mark, asset number, lessee, fleet, rider, asset management type, commercial transportation status, equipment group, error events, and/or the like corresponding to rail assets owned, leased, and/or sub-leased by an entity and/or employer associated with the user (e.g., based at least in part on the corresponding user profile). A user may also provide (e.g., via user interaction with the rail AM IUI 400) filter criteria for filtering results of the search/query. FIG. 7 provides an example view of equipment or rail asset search results 700 provided via an asset tab 430 of the rail AM IUI 400 responsive to a user submitting a query of the asset database (e.g., via user interaction with the equipment or rail asset search 600).

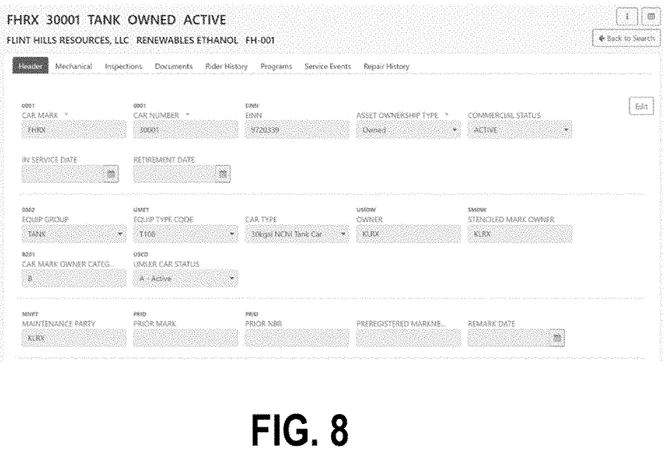

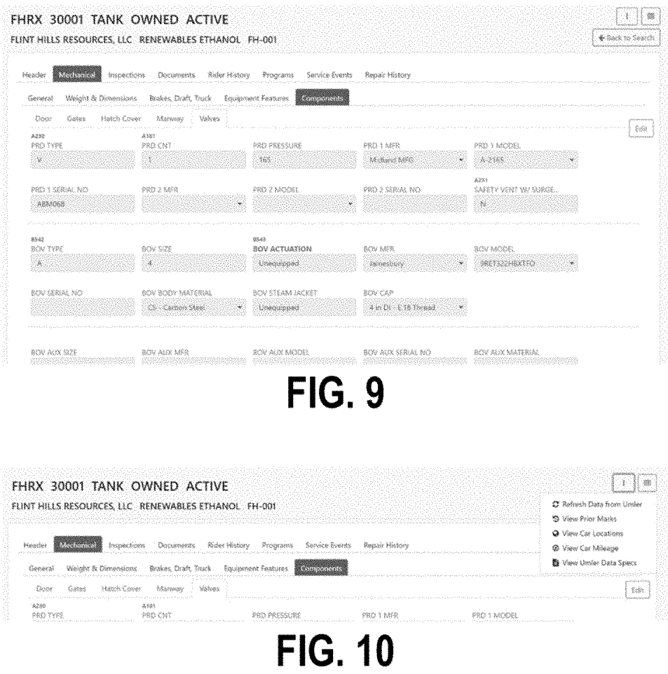

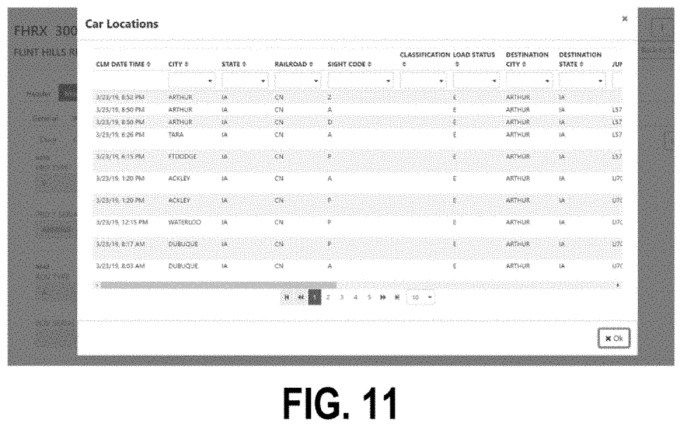

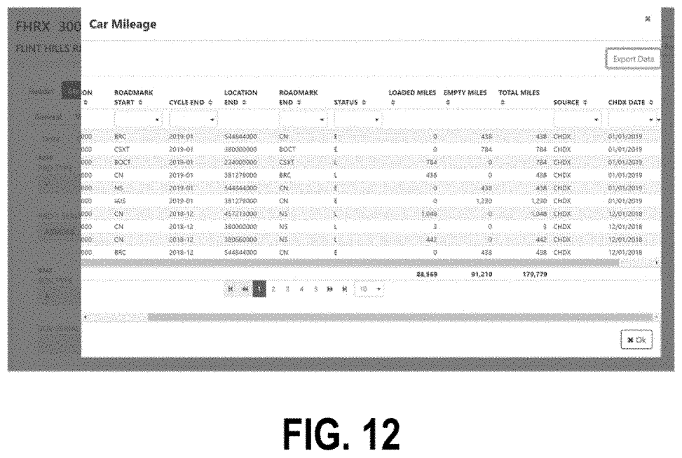

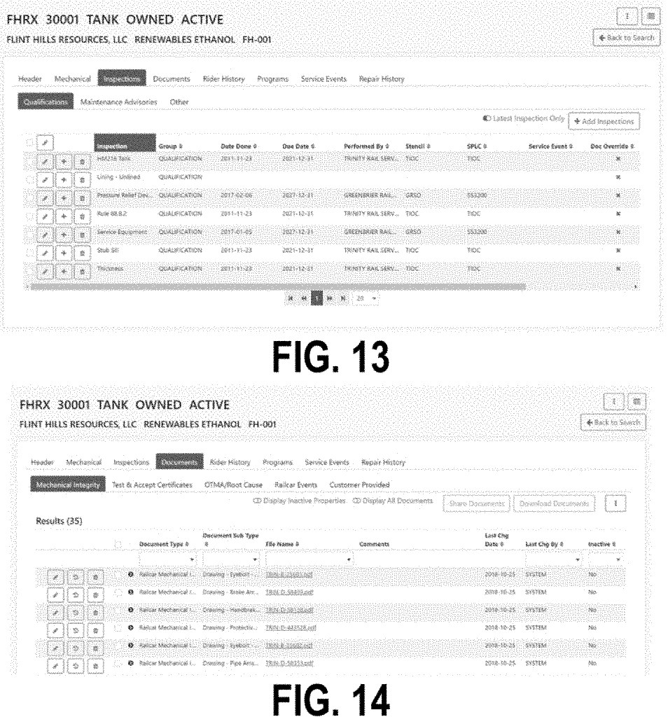

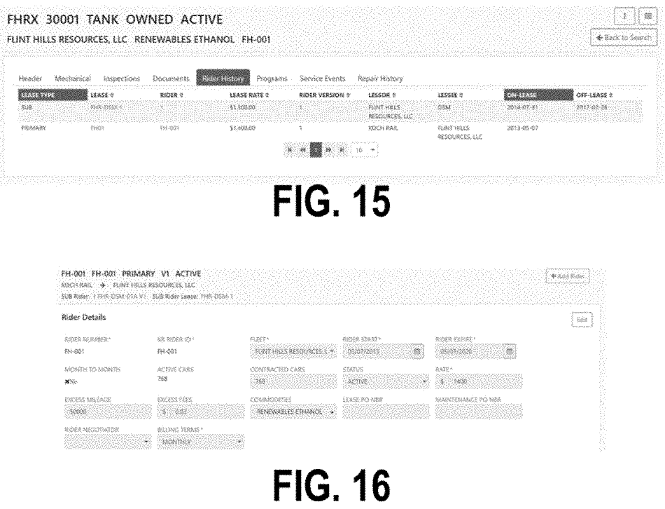

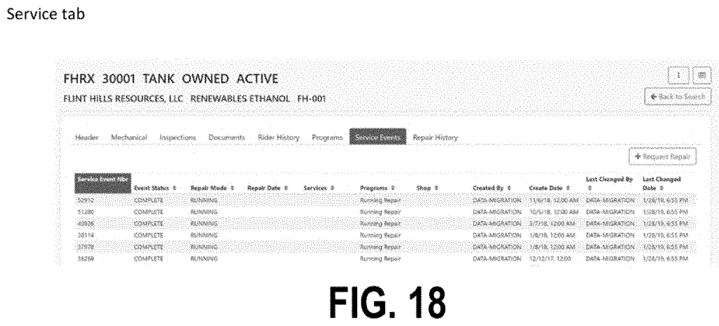

FIG. 8 shows an equipment/asset landing page 800 provided via the asset tab 430 responsive to receiving user input selecting a particular result from the equipment or rail asset search results 700. The equipment/asset landing page 800 provides the user with asset information/data regarding the user-selected rail asset and provides the user with access to a mechanical tab providing asset information/data corresponding to the mechanical integrity of the rail asset (see FIGS. 9-12), an inspections tab providing asset information/data corresponding to the inspection history (and possibly expected upcoming inspections) of the rail asset (see FIG. 13), a documents tab providing access to documents corresponding to the rail asset (see FIG. 14), a rider history tab providing access to asset information/data corresponding to riders that the rail asset is currently and/or has previously been associated with and/or leased under (see FIGS. 15-17), a programs tab providing information/data relating to service programs that the rail asset has been assigned to and/or is eligible for being assigned to, a service events tab providing service information/data corresponding to service events corresponding to the rail asset (see FIG. 18), and a repair history tab providing service information/data corresponding to past repairs, refabrication, specialization, customization, and/or the like of the rail asset, and/or the like. As can be seen in, for instance, FIG. 10, the asset tab 430 of the rail AM IUI 400 may also provide the user with selectable elements (e.g., a menu of selectable elements) for requesting traveling information/data updates from an external computing entity 20 (e.g., an Umler computing entity), viewing prior marks for a rail asset, viewing a current and/or previous locations of the rail asset, viewing rail asset distance (e.g., mileage, kilometrage) (e.g., as determined based at least in part on the travel information/data), viewing the Umler information/data specs corresponding to the travel information/data and/or the rail asset, and/or the like. In various embodiments, the information/data provided for a rail asset (e.g., via various views, examples of which are shown in FIGS. 8-18) may be particular to the equipment group/type associated with the rail asset.

### Exemplary Lease Tab/Lease Management

In various embodiments, the lease tab 440 may provide a user (e.g., operating a user computing entity 30) with information/data regarding leases and associated riders to which the entity and/or employer associated with the user (e.g., based at least in part on the user profile corresponding to the user) are a party to. For example, a user may use the lease tab 440 to search for leases, view lease search results, view a history of lease changes, update a lease, create a new lease, view and navigate riders under a selected lease, view a portable document file (pdf) or other document format of the lease for which the entity and/or employer associated with the user is a party to the lease and/or rider.

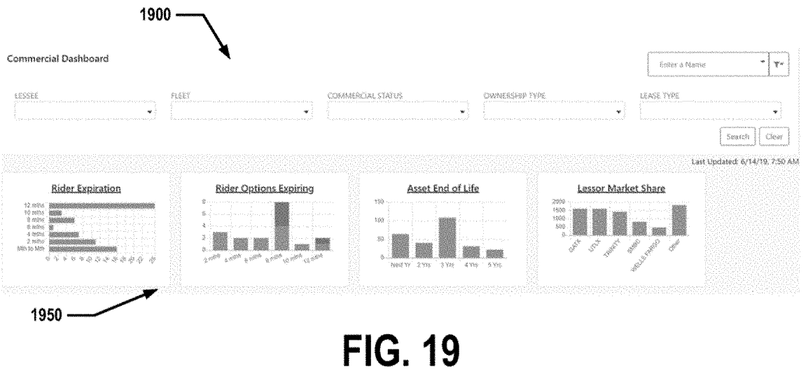

FIG. 19 provides an example view of a lease tab 440 landing page. In various embodiments, the lease tab 440 landing page may comprise a lease search portion 1900 and a lease dashboard portion 1950. In various embodiments, the lease dashboard portion 1950 may provide the user with an overview of leases and/or sub-leases to which the entity and/or employer associated with the user is a party, alerts regarding urgent matters corresponding to leases to which the entity and/or employer associated with the user is a party, notifications regarding items relating to leases to which the entity and/or employer associated with the user is a party that require the user's attention, and/or the like. In various embodiments, the lease search portion 1900 enables the user to enter and/or select (e.g., via interaction with the rail AM IUI 400 via one or more user input devices/interfaces of the user computing entity 30) search criteria for searching leases and/or corresponding riders to which the entity and/or employer associated with the user is a party. In an example embodiment, a user may search for leases based at least in part on asset management type, lease identifier, a lessor lease identifier configured to identify the lease in a lease management system of the lessor party of the lease, a lessee lease identifier configured to identify lease in a lease management system of the lessee party of the lease, a lessor identifier configured to identify the lessor party of the lease, a lessee identifier configured to identify the lessee party of the lease, a lease status (e.g., active, expired, pending (e.g., has not yet been active)), a lease type (e.g., primary, pass-through, sub-lease), start date, expiration date, and/or the like. In various embodiments, a user may also be able to search riders.

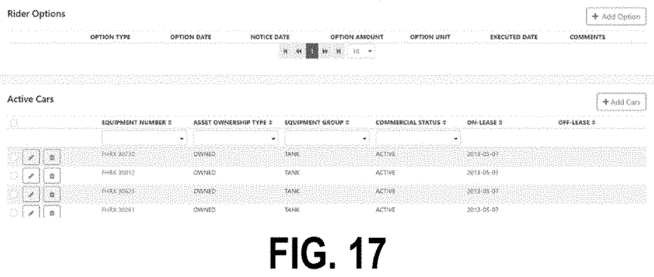

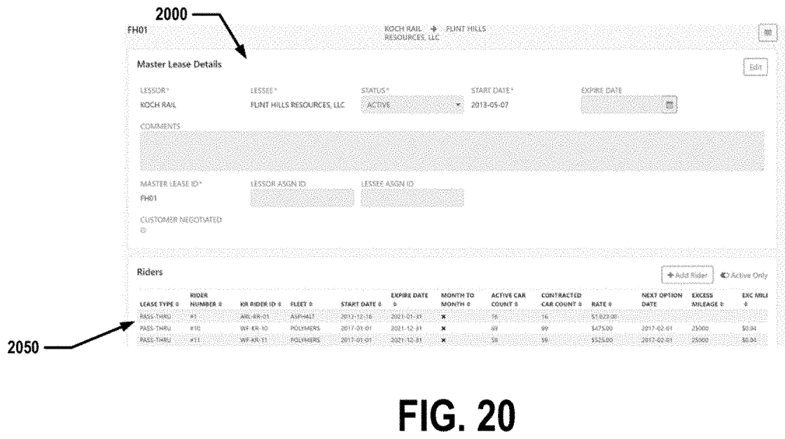

When a user selects a lease from one or more search results identified and/or provided in response to the user submitting a lease query (e.g., by entering search criteria via the lease search portion 1900 and selecting the selectable submission element of the lease search portion 1900), the user may be provided with a lease view of the rail AM IUI 400, an example of which is shown in FIG. 20. In an example embodiment, the lease view comprises a master lease portion 2000 and a rider portion 2050. In various embodiments, a lease may be associated with one or more riders. In various embodiments, a rider may provide one or more options to a lease, assign one or more rail assets to a lease, provide a sub-lease, and/or the like. When a user selects one of the riders listed in the rider portion 2050, the user may be provided with a rider detail view, similar to that shown in FIGS. 16-17.

In various embodiments, a lease may be associated with a lease type. In various embodiments, the type of a lease may be one of a primary lease, pass-through lease, or sub-lease. In an example embodiment, under a primary lease, the lessee operates and/or controls the operation of the rail asset; under a pass-through lease, an organization and/or company other than the lessee operates and/or controls the operation of the rail asset; and, under a sub-lease, a lessee leases the rail asset to a sub-lessee for operation and/or control of the operation of the rail asset. In various embodiments, a rider may be associated with a lease type which is inherited from the parent lease. In various embodiments, a rider may identify the parent rider, such that riders may be attached to a lease in a hierarchical manner.

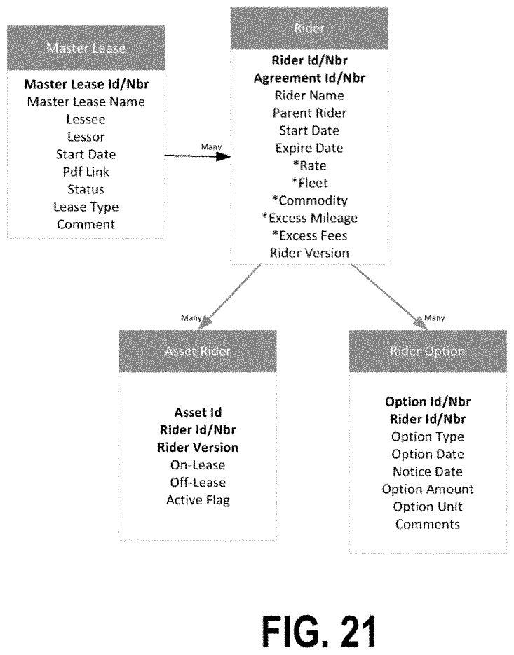

As shown in FIG. 21, in various embodiments, lease information/data corresponding to a lease comprises a lease identifier configured to identify the lease, a lessor lease identifier configured to identify the lease in a lease management system of the lessor party of the lease, a lessee lease identifier configured to identify the lease in a lease management system of the lessee party of the lease, a lessor identifier configured to identify the lessor party of the lease, a lessee identifier configured to identify the lessee party of the lease, a lease status (e.g., active, expired, pending (e.g., has not yet been active)), a lease type (e.g., primary, pass-through, sub-lease), start date, expiration date, links to corresponding documents, and/or the like. A lease may have a one or more riders associated therewith. In an example embodiment, a rider may include a rider identifier configured to identify the rider, an agreement identifier, a lease identifier configured to identify the parent lease, a rider name, a parent rider identifier (if applicable), a rider start date, a rider expiration date, a rate corresponding to the rent of one or more rail assets, fleet information/data, commodity information/data (e.g., corresponding to the commodity to be transported via the rail asset(s) assigned to the lease), an excess distance (e.g., mileage, kilometer age) rate, excess fee information/data, a rider version, and/or the like. In various embodiments, a rider may be a parent rider to one or more asset riders. In various embodiments, rail assets are assigned to leases via an asset rider. For example, an asset rider may include an asset rider identifier, a parent rider identifier, an asset identifier identifying the rail asset being assigned to the lease, a rider version, an on-lease date indicating the date the rail asset is to begin to be assigned to the lease, and off-lease date indicating the date the rail asset is to end being assigned to the lease, and an active flag indicating whether or not the rail asset is active under the lease. In various embodiments, an option rider may be associated with one or more parent riders. In various embodiments, an option rider may include an option rider identifier, a parent rider identifier, an option type, an option date when the option takes effect, a notice date, an option amount, an option unit, comments, and/or the like. In various embodiments, one or more riders may provide an early termination option. In various embodiments, the early termination option may correspond to one or more asset riders (e.g., one or more particular rail assets). In various embodiments, the lease tab 440 may provide notifications and/or alerts regarding early termination options, upcoming expiring riders, and/or upcoming expiring leases based at least in part on predictive analytics. Further, because rail assets are often subleased in periods of length and low utilization, the rail AM system allows for “back-to-back” payment and rebilling to external parties. The rail AM system (a) allows for multiple tier subleases with divergent pricing so that costs may be passed through, or marked up for gain, (b) allows users to create rental invoices for owned or subleased railcars, and (c) create/generate reports summing any remaining capital expenditures for leased cars monthly, by customer, and/or the like.

In various embodiments, when the user profile corresponding to the user has the appropriate permissions, the user may generate one or more new leases and/or riders corresponding to existing leases, upload documents corresponding to leases and/or riders, and/or the like, by interacting with the rail AM IUI 400. In various embodiments, when a lease or rider is updated and/or modified, the previous version is maintained, and a new version of the lease or rider is generated and stored. The new version of the lease or rider may have the same lease identifier or rider identifier as the previous version of the lease or rider, but a different version number.

### Exemplary Service Tab/Service Management

In various embodiments, the service tab 450 may provide a user (e.g., operating a user computing entity 30) with information/data regarding services for one or more rail assets owned, leased, and/or sub-leased by an entity and/or employer associated with the user (e.g., based at least in part on the user profile corresponding to the user). In various embodiments, the service tab 450 may provide information/data regarding current and/or ongoing service events (e.g., rail assets that are currently in the shop), predicted service events (e.g., maintenance that will be due for one or more rail assets in the next month, quarter, six months, year, two years, and/or the like), and/or other completed service events (e.g., maintenance completed in the past month, quarter, six months, year, two years, ten years, and/or the like). In an example embodiment, a user may initiate a service request and/or service event via the service tab 450. In an example embodiment, the service tab 450 may provide the user with communication tools for communicating with a shop regarding one or more service events.

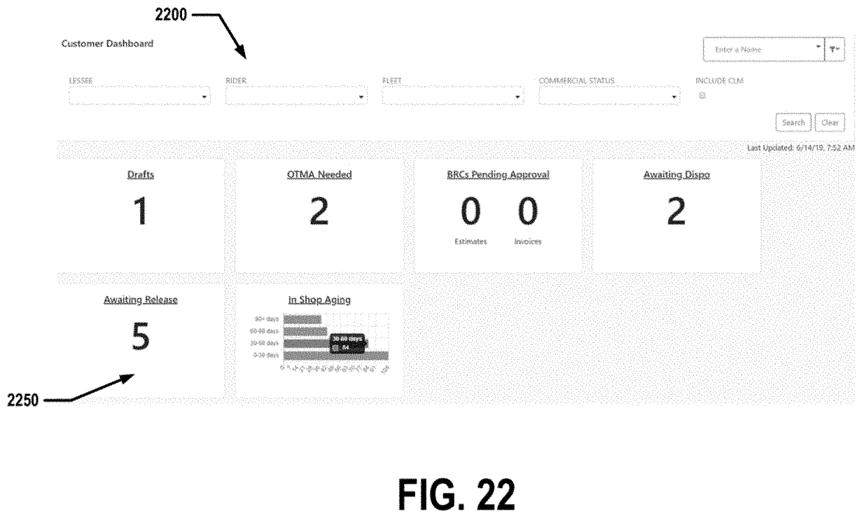

FIG. 22 provides an example view of a service tab 450 landing page. In various embodiments, the service tab 450 landing page may comprise a service search portion 2200 and a service dashboard portion 2250. In various embodiments, the service dashboard portion 2250 may provide the user with an overview of services that are expected to be performed, are ongoing, and/or recently completed that relate to rail assets owned, leased, and/or sub-leased by the entity and/or employer associated with the user, alerts regarding urgent matters corresponding to services for rail assets owned, leased, and/or sub-leased by the entity and/or employer associated with the user, notifications regarding items relating to services for rail assets owned, leased, and/or sub-leased by the entity and/or employer associated with the user that require the user's attention, and/or the like. In various embodiments, the service search portion 2200 enables the user to enter and/or select (e.g., via interaction with the rail AM IUI 400 via one or more user input devices/interfaces of the user computing entity 30) search criteria for searching current, upcoming, and/or past service events (e.g., based at least in part on BRCs and/or the like) corresponding to rail assets owned, leased, and/or sub-leased by the entity and/or employer associated with the user.

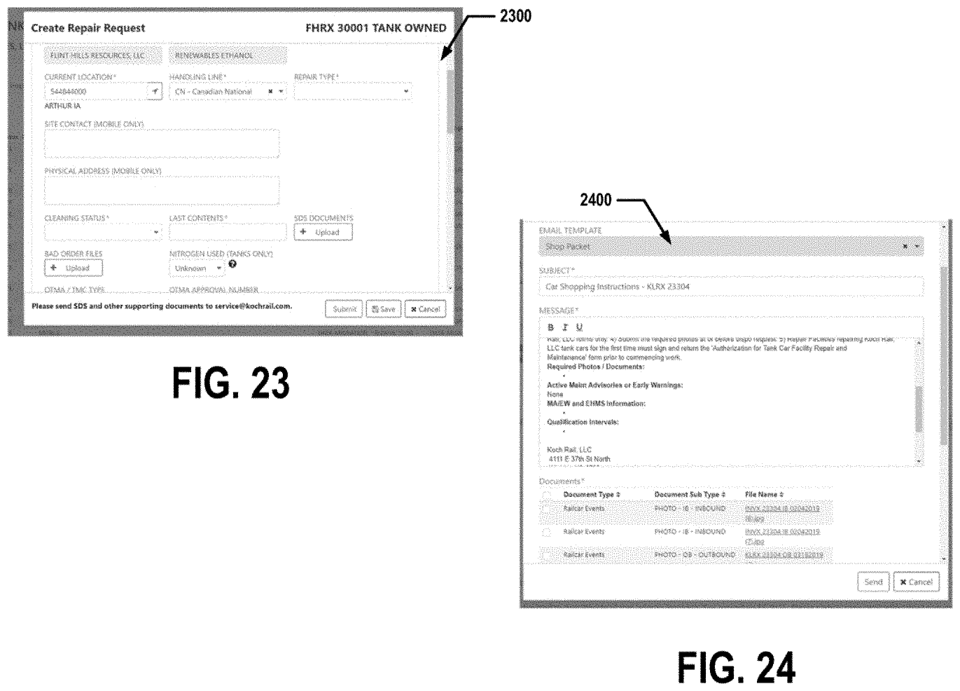

In various embodiments, the user (e.g., operating a user computing entity 30) may request service for a rail asset. FIG. 23 provides an example service request form 2300 of the rail AM IUI 400. Via the service request form 2300, the user may define and/or select a repair type, upload and/or attach documents corresponding to the rail asset that may be relevant to the performance of the service, upload and/or attach photographs and/or diagrams/drawings of defects to be repaired, provide information/data relevant for the service, and/or the like.

In response to receiving an indication of a user selecting a selectable submit element of the service request form 2300, the server system 10 may generate a form service request (e.g., possibly in the form of a form email) to a shop requesting service of the rail asset. FIG. 24 provides a draft view of the service request 2400 to be provided to the shop (e.g., sent to an email address or other electronic destination address associated with a shop based at least in part on, for instance, a shop profile corresponding to the shop). As shown in FIG. 24, the draft view of the service request 2400 includes the documents and/or photographs uploaded and/or attached to the service request form 2300 as attachments and includes instructions for performing the service based at least in part on the information/data provided, entered, and/or selected by the user via the service request form. In an example embodiment, the draft view of the service request 2400 is provided to a user (e.g., via the AM IUI 400 provided via the user interface of the user computing entity 30) in an editable manner. The user may edit the form email and/or select the selectable submit element. Responsive to receiving input (e.g., via a user input device/interface) of the user selecting the selectable submit element, the user computing entity 30 may provide an indication of the submission of the service request such that the server system 10 receives the indication of submission of the service request, generates and assigns a service event number (e.g., service event identifier) to the service event corresponding to the service request, and causes the service request (including the service event number) to be forwarded to an electronic destination address (e.g., email) of a shop. In an example embodiment, the shop is selected by the user when filling the service request form 2300.

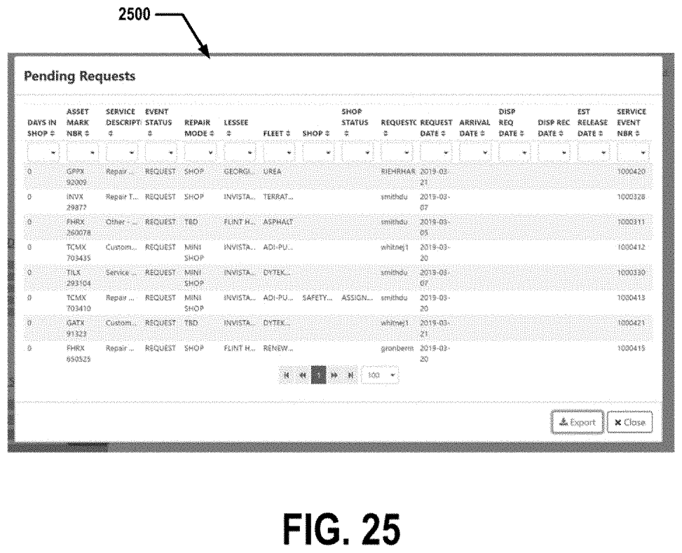

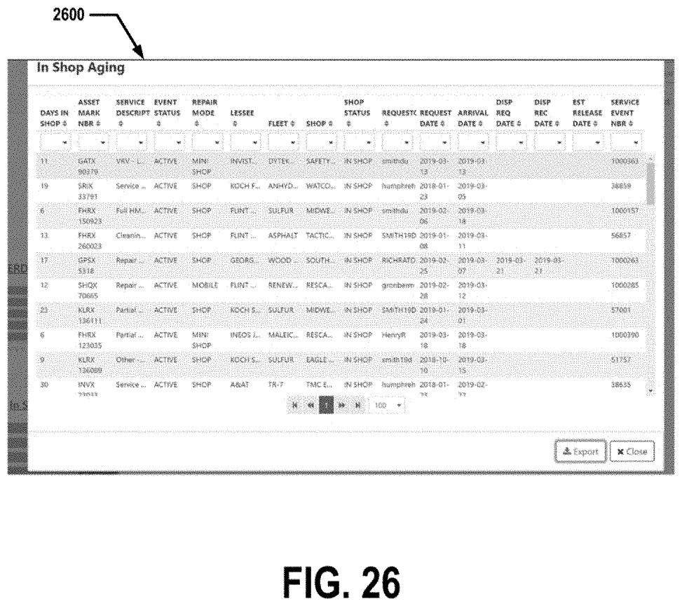

Once a service request has been submitted, the status of the service request may be monitored via a pending service view 2500 of the rail AM IUI 400. FIG. 25 illustrates an example pending service view 2500 of the rail AM IUI 400 showing the status and other information/data regarding a plurality of service events corresponding to rail assets owned, leased, and/or sub-leased by the entity and/or employer associated with the user accessing the rail AM IUI 400. In various embodiments, the status of a service event may be monitored via an in-shop aging view 2600, an example of which is provided in FIG. 26. The in-shop aging view 2600 of the rail AM IUI 400 provides the status and other information/data regarding a plurality of service events corresponding to rail assets owned, leased, and/or sub-leased by the entity and/or employer associated with the user accessing the rail AM IUI 400, including the amount of time the rail asset has been in the shop. In various embodiments, at least a portion of the service information/data provided via the pending service view 2500 and/or in-shop aging view 2600 is extracted from the service request and/or service request form.

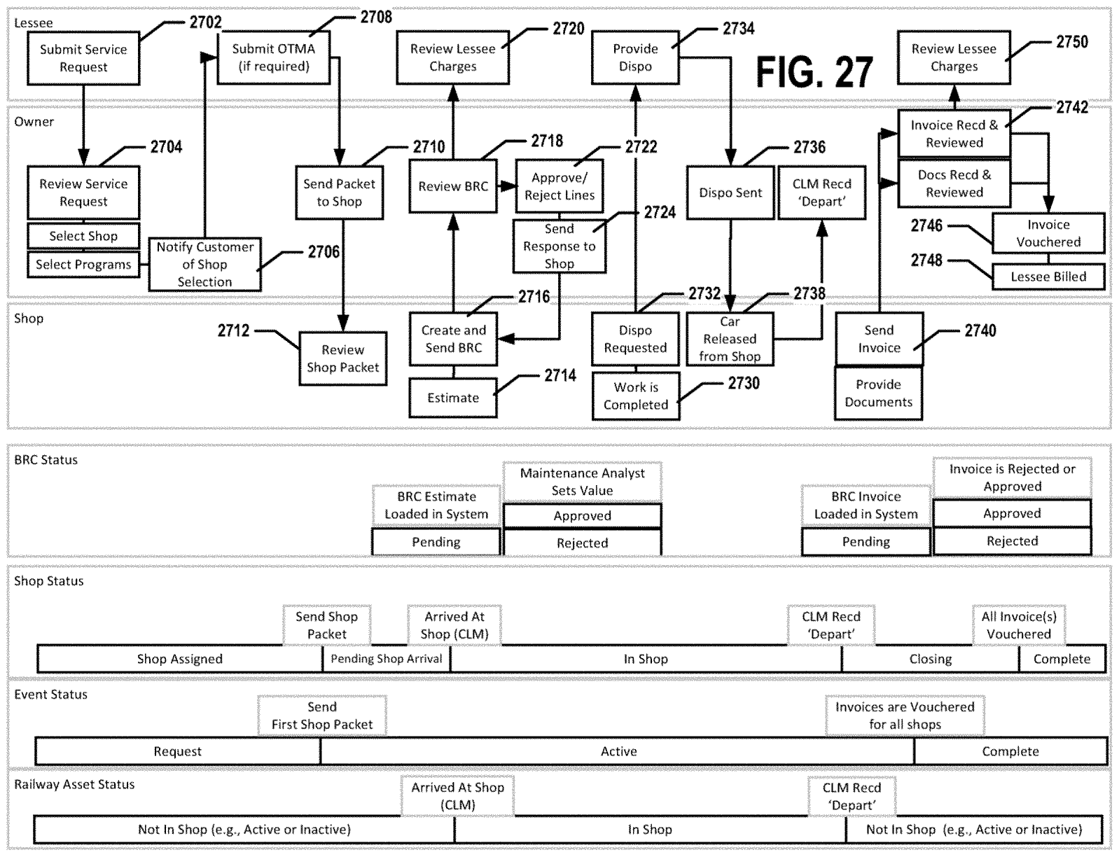

FIG. 27 provides a flow diagram illustrating the flow of information/data used to manage a service event, in accordance with an example embodiment. Starting at step/operation 2702, a user associated with an entity and/or employer that is operating and/or controlling the operation of the rail asset submits a service request. For example, the user (e.g., operating a user computing entity 30) may access a service request form 2300, populate at least the required fields of the service request form, and submit the service request form to generate a service request.

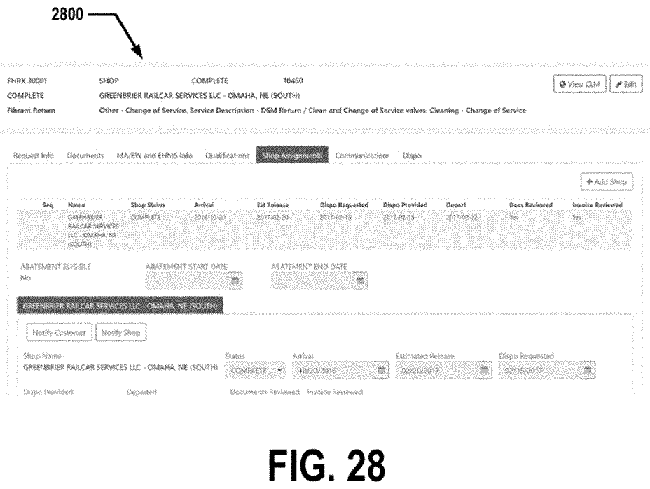

The server system 10 may receive the service request form, generate the service request based thereon, and provide the service request (e.g., the draft view of the service request 2400) to a user computing entity 30 operated by a user associated with the entity and/or employer that owns the rail asset. The user may review the draft view of the service request 2400, possibly make one or more changes to the service request, select a shop for performing the service, select one or more service programs, and/or the like. FIG. 28 provides an example view of a shop assignment sub-tab 2800 of the service tab 450, according to an example embodiment.

In various embodiments, a rail asset may be eligible for a one or more service programs (e.g., performance of maintenance, repairs, refabrication, specialization, customization, and/or the like of a predetermined scope). For instance, if the rail asset is due for maintenance work in three months, a user associated with an entity and/or employer that owns the rail asset may decide to have the maintenance performed while the rail asset is having an unscheduled service performed such that the rail asset may not have to return to the shop in a few months. In an example embodiment, the programs that the asset (e.g., railcar) is eligible for may depend on the shop that the rail asset is being sent to and the capabilities and/or equipment of that shop. In an example embodiment, the user (e.g., operating the user computing entity 30) may make any changes to the service request and submit the service request. The rail AM system can also provide a prompt at the time of service event creation with all open and upcoming inspections due so that a service event may resolve as many open items as possible and minimize future opportunity cost for the rail asset.

In general, a program is a set of planned work (e.g., maintenance, updating, and/or the like) that needs to happen to one or more rail assets. The program is defined and then one or more rail assets may be added to the program. A user may search and view programs via the service tab 450. In various embodiments, a program may be generated by generating and storing a program profile in a program data store (e.g., program database) stored by a server system 10 and/or accessible to a system computing entity 10. For example, the program profile may include a program identifier, a program name, a program status (e.g., not started, in progress, on hold, close out, complete, canceled), program type (e.g., non-qualification inspection, change of service, end of line/scrap, sublease in, existing asset lease, existing asset purchase, new asset lease, new asset purchase, lease expiration, sales, reassignment, sublease out, full early qualification, partial early qualification, full qualification, partial qualification, preventive maintenance, general maintenance, maintenance advisory, and/or the like), program group (e.g., projects, qualifications, preventive maintenance, may correspond to program type), internal only (e.g., a true/false flag indicating whether or not other parties will be able to view information/data corresponding to the program), qualification year (e.g., if the program is of the program group qualifications), lessee, rider, fleet, expected lessee cost per asset, expected lessor cost per asset, program begin date, program expected due date, comments, and/or the like. In various embodiments, one or more asset statistics of a program may be tracked and provided for viewing via the service tab 450. For example, the asset statistics of a program may include number of rail assets associated with the program, number of rail assets that have service events (e.g., service event data objects within the service event database) associated with the program, number of rail assets that are currently in the shop for a service event associated with the program, number of cars with completed service events associated with the program, number of rail assets left to be serviced as part of the program (e.g., number of associated rail assets minus number of rail assets currently in the shop for service events associated with the program minus number of cars with completed service events associated with the program. When a user (e.g., operating a user computing entity 30) selects, clicks and/or the like one of the asset statistics, the user may be provided (e.g., via the rail AM IUI 400, possibly via a pop-up window) a corresponding list of rail assets.

Continuing with FIG. 27, the server system 10 may receive the submitted service request. The server system 10 may provide a shop selection notification to the lessee (e.g., to a user computing entity 30 associated with a user associated with an entity and/or employer that operates and/or controls the operation of the rail asset) at step/operation 2706. For example, the shop selection notification may indicate which shop the rail asset is to be sent to, directions on how to transport the rail asset from its current location to the selected shop, and/or the like. For instance, the shop selection notification may indicate which lines, short lines, and/or the like service the shop; the schedule of various switches and/or trains along the lines, short lines, and/or the like between the current location of the rail asset and the shop; switch fees for switches between the current location of the rail asset and the shop; and/or other information/data that may be useful in transporting the rail asset from its current location to the shop.

At step/operation 2708, a user associated with an entity and/or employer that operates and/or controls the operation of the rail asset to submit a one-time movement approval (OTMA). In various embodiments, the user computing entity 30 being operated by the user associated with the entity and/or employer that operates and/or controls the operation of the rail asset may provide the OTMA such that the server system 10 receives the OTMA.

At step/operation 2710, the server system 10 may generate a shop packet (e.g., the shop request and any attachments) and/or provide the shop packet to a shop. For example, the server system 10 may provide the shop packet such that the shop packet is delivered to an electronic destination address (e.g., email and/or the like) associated with the shop such that a user associated with the shop may view the shop packet via shop IUI via user interface of a user computing entity 30. In an example embodiment, the shop IUI is provided by the rail AM system and, rather than the shop packet being provided via an email and/or the like, the shop packet may be made available to one or more users associated with the shop via the shop IUI and a notification of the new shop packet and/or service request (e.g., a new service event associated with the and/or assigned to the shop) may be provided to one or more users associated with the shop.

At step/operation 2712, one or more users associated with the shop may review the shop packet (e.g., service request and any attachments). For instance, a user associated with the shop may review the shop packet via a user interface of a user computing entity 30. In various embodiments, the user associated with the shop may provide user input (e.g., via a user input device/interface of the user computing entity 30) acknowledging the shop packet, accepting the service request and/or the like. The user computing entity 30 may then provide an indication of the acknowledgement and/or acceptance of the service request such that the server system 10 receives the indication of the acknowledgement and/or acceptance of the service request.

In various embodiments, when the user associated with the entity and/or employer that is operating and/or controlling the operation of the rail asset submits the service request form 2300 (e.g., via the service tab 450 of the rail AM IUI 400), a service event is generated with the status of “request.” In various embodiments, the service event is represented by a service event data object comprising the asset identifier, the asset mark/number, a description of the requested scope of service, and/or other information/data extracted from the service request form 2300 and/or the asset profile. In various embodiments, the service event data object is stored in a service data store and/or in association with the asset profile corresponding to the asset in a data store (e.g., asset database, service database, and/or the like) that is stored by and/or accessible to the server system 10 (e.g., in memory 110, 115). In various embodiments, when the server system 10 receives the indication of the acknowledgement and/or acceptance of the service request provided by the user computing entity 30 being operated by the user associated with the shop, the service event status may be updated from “request” to “active.”

In various embodiments, the service event data object may further include a shop status field. In various embodiments, when the service event data object is generated and/or initiated, the shop status field is set to “unassigned.” When the user associated with the entity and/or employer that owns the rail asset assigns the service request to a shop (e.g., at step/operation 2704), the shop status may be updated to “assigned” and/or may include the name of the shop and/or a shop identifier configured to identify the shop. In various embodiments, when the server system 10 receives the indication of the acknowledgement and/or acceptance of the service request provided by the user computing entity 30 being operated by the user associated with the shop, the shop status may be updated to “pending shop arrival.”

The rail asset may then be transported to one or more shops. When the rail asset arrives in as shop, a user associated with the shop and/or a user involved in transporting the rail asset to the shop may operate a user computing entity 30 to submit an asset (e.g., railcar) location message (CLM) indicating that the rail asset is located at the shop, in an example embodiment. In another example, the railway network 500 may determine that the current location of the rail asset is the shop (e.g., based at least in part on a sensor 504A-504D located at or near the shop detecting the presence of an identifier provider 514 physically associated with the rail asset 512) and provide and/or submit the CLM indicating that the rail asset is located at the shop. In various embodiments, a user computing entity 30 and/or an external computing entity 20 may provide a CLM indicating that the rail asset is located at the shop such that the server system 10 receives the CLM indicating that the rail asset is located at the shop. Responsive to receiving the CLM, the server system 10 may update the shop status of the service event data object to “in shop” and/or may update the status of the rail asset (e.g., in the asset profile) to “in shop.” Because some repairs may require multiple shops to repair or execute out of service events, the rail AM system allows a one-to-many relationship between events and shops. This allows the rail AM system to associate all repair information/data and costs to an event, regardless of number of vendors, and provides owners, lessees, and business with better visibility into total down time and cost.

In various embodiments, based at least in part on the shop packet and/or inspection of the rail asset, a user associated with the shop (e.g., operating a user computing entity 30) may generate and submit an estimate, at step/operation 2714. Responsive to the user associated with the shop submitting the estimate (e.g., via interaction with one or more user input devices/interfaces of the user computing entity 30), the user computing entity 30 may provide the estimate such that the server system 10 receives the estimate. Responsive to receiving the estimate, the server system 10 may generate a BRC with a status of “pending” and including information/data from the estimate. In various embodiments, a BRC is a data object having a defined format. For example, the BRC may be an industry standard file type/format having 500 bytes. In an example embodiment, the user computing entity 30 may generate the BRC (e.g., with the status of “pending”) and provide the estimate by providing the BRC such that the server system 10 receives the BRC. For example, the user computing entity 30 operated by the user associated with the shop to generate the estimate may generate and provide the BRC at step/operation 2716.

In an example embodiment, the BRC received by the server system 10 may comprise a service event identifier (e.g., the service event number) identifying the service event to which the BRC corresponds. In an example embodiment, the server system 10 may compare one or more elements of meta data and/or fields of the BRC to the elements and/or fields of the service event data object corresponding to the service event identified by the service event identifier of the BRC. For instance, the server system 10 may confirm that the BRC and/or corresponding metadata and the service event data object identified by the service event identifier included in the BRC and/or corresponding metadata include the same asset identifier, shop identifier, equipment group/type indicator, owner identifier, and/or the like. In an example embodiment, the BRC received by the server system 10 does not include a service event identifier and that server system 10 may match the BRC to a service event. For example, service event data objects may be searched and/or queried to determine if there are any service events associated with the asset identifier of the BRC and/or corresponding metadata that has a scope and/or time frame similar to that of the BRC. If a service event data object comprising a matching asset identifier and/or scope with the BRC and/or corresponding metadata, it may be determined that the BRC corresponds to the matching service event data object and the BRC may be associated with the service event identifier of the service event data object. If a matching service event data object is not identified automatically by the server system 10, a notification may be provided to a user (e.g., associated with the entity and/or employer owning the rail asset corresponding to the asset identifier of the BRC and/or corresponding metadata) via a corresponding user computing entity 30 such that the user may determine if a matching service event exists and/or if a service event should be manually generated and associated with the BRC.

At step/operation 2718, the BRC may be provide (e.g., by the server system 10) such that a user computing entity 30 associated with a user associated with the entity and/or employer that owns the rail asset. A user associated with the entity and/or employer that owns the rail asset may then review the BRC (e.g., via the user interface of the user computing entity 30). Additionally, the server system 10 may determine the lessee charges (e.g., the shop work to be billed to the lessee) based at least in part on lease and/or rider information/data corresponding to the rail asset and provides a lessee charge estimate to a user computing entity 30 associated with a user associated with the entity and/or employer that operates and/or controls operation of the rail asset. A user associated with the entity and/or employer that operates and/or controls operation of the rail asset may then review the lessee charge estimate. In an example embodiment, the user associated with the entity and/or employer that operates and/or controls operation of the rail asset may provide user input (e.g., via a user input device/interface of the user computing entity 30) acknowledging and/or accepting the lessee charge estimate. Responsive to receiving and/or registering the user input acknowledging and/or accepting the lessee charge estimate, the user computing entity 30 may provide an indication of the user input acknowledging and/or accepting the lessee charge estimate such that the server system 10 receives the user input acknowledging and/or accepting the lessee charge estimate.

In various embodiments, at step/operation 2722, the user associated with the entity and/or employer that owns the rail asset reviewing the BRC may accept and/or reject one or more lines of the BRC (e.g., via user input provided via a user input device/interface of the user computing entity 30). The user associated with the entity and/or employer that owns the rail asset reviewing the BRC may then provide user input (e.g., via user input provided via a user input device/interface of the user computing entity 30) submitting the amended BRC (e.g., the BRC including the indication of approved and/or rejected lines). In response to receiving the user input submitting the amended BRC, the user computing entity 30 operated by the user associated with the entity and/or employer that owns the rail asset may provide the amended BRC such that the server system 10 receives the amended BRC. In various embodiments, if each line of the amended BRC indicates that the line was accepted, the server system 10 may provide an indication that the BRC was accepted such that the indication is received by a user computing entity 30 associated with a user associated with the shop. In various embodiments, if one or more lines of the amended BRC indicate that the line was rejected, the server system 10 may provide an indication of which lines of the BRC were rejected and/or which lines of the BRC were accepted such that the indication is received by a user computing entity 30 associated with a user associated with the shop. The shop and the entity and/or employer owning the rail asset may then engage in a negotiation (e.g., via the rail AM IUI 400, in an example embodiment) until a BRC is generated for which each line is accepted. While the negotiation is underway, the BRC status may be “rejected.” Once BRC is generated for which each line is accepted, the status of the BRC is set to “accepted.” In an example embodiment, rather than amending the BRC, a plurality of versions of the BRC may be generated and/or stored (e.g., in memory 110, 115) in a service database and/or the like.

The shop may then perform the service as outlined by the BRC corresponding to the service event (e.g., comprising the service event identifier) and having the “active” BRC status. Once the service is completed, a user associated with the shop may operate a user computing entity 30 to submit a work completed message. In various embodiments, the work completed message may include documents and/or information/data detailing the work performed by the shop. At step/operation 2730 a work completed message is submitted via the user computing entity 30 and provided (e.g., by the user computing entity 30) such that the user computing entity 30 receives the work completed message. In various embodiments, in response to receiving the work completed message, the server system 10 may update the BRC status to indicate that the work has been completed. In response to receiving user input submitting the work completed message, the user computing entity 30 and/or server system 10 may generate and provide a disposition request. The disposition request may be provided (e.g., by the user computing entity 30 and/or server system 10) such that a user computing entity associated with the entity and/or employer operating and/or controlling the operation of the rail asset receives the disposition request and provides the disposition request via a user interface thereof (e.g., via the service tab 450 of the rail AM IUI 400). A user associated with the entity and/or employer operating and/or controlling the operation of the rail asset may (e.g., via a user computing entity 30) provide disposition instructions, at step/operation 2734. In various embodiments, the disposition instructions indicate a disposition location to which the rail asset should be transported to such that the rail asset may be put back into use; directions on how to transport the rail asset from the shop to the disposition location, and/or the like. For instance, the disposition instructions may indicate which lines, short lines, and/or the like service the disposition location; the schedule of various switches and/or trains along the lines, short lines, and/or the like between the shop and the disposition location; switch fees for switches between the shop and the disposition location; and/or other information/data that may be useful in transporting the rail asset from the shop to the disposition location. In various embodiments, the user computing entity 30 may provide the disposition instructions such that a server system 10 receives the disposition instructions.

At step/operation 2736, the disposition instructions are provided to a user computing entity associated with a user associated with the entity and/or employer that owns the rail asset. The user may review the disposition instructions and may provide user input (e.g., via a user input device/interface and/or the like of the user computing entity 30) indicating approval and/or acknowledgement of the disposition instructions. The user computing entity 30 may provide an indication of the user input indicating approval and/or acknowledgement of the disposition instructions such that the server system 10 receives the indication. In response to receiving the indication of the user input indicating approval and/or acknowledgement of the disposition instructions, the server system 10 may provide the disposition instructions such that a user computing entity 30 associated with a user associated with the shop receives the disposition instructions. After receiving the disposition instructions, the rail asset may be released from the ship at step/operation 2738.

The rail asset may then be transported from the shop to the disposition location. When the rail asset leaves the shop, a user associated with the shop and/or a user involved in transporting the rail asset from the shop may operate a user computing entity 30 to submit an asset (e.g., railcar) location message (CLM) indicating that the rail asset has left the shop, arrived at the disposition location, and/or the like, in an example embodiment. In another example, the railway network 500 may determine that the current location of the rail asset is no longer the shop (e.g., based at least in part on a sensor 504A-504D located somewhere other than the shop and/or at or near the disposition location detecting the presence of an identifier provider 514 physically associated with the rail asset 512) and provide and/or submit the CLM indicating that the rail asset has left the shop and/or is located at the disposition location. In various embodiments, a user computing entity 30 and/or an external computing entity 20 may provide a CLM indicating that the rail asset has left the shop and/or is located at the disposition location such that the server system 10 receives the CLM. Responsive to receiving the CLM, the server system 10 may update the shop status of the service event data object to “closing” and/or may update the status of the rail asset (e.g., in the asset profile) to “out of shop.”

In various embodiments, a service event may be associated with a plurality of shops and the rail asset may be transported between two or more shops for the work to be completed. In an example embodiment, a BRC may be generated and stored for each shop and the work to be performed by that shop as part of the service event. In such embodiments, the status of the service event may indicate which shop the rail asset is currently “in shop” at.

At step/operation 2740, a user associated with the shop may operate a user computing entity 30 to provide one or more documents corresponding to the service event and an invoice for the service performed by the shop. In various embodiments, the user computing entity 30 may provide the one or more documents corresponding to the service event and the invoice for the service performed by the shop such that the server system 10 receives the documents and invoice. In an example embodiment, the server system 10 may automatically associate the one or more documents corresponding to the service event with the rail asset and store a link to the one or more documents in the asset profile corresponding to the rail asset. In an example embodiment, the server system 10 may provide the one or more documents corresponding to the service event and/or the invoice for the service performed by the shop to a user computing entity 30 associated with a user associated with the entity and/or employer owning the rail asset.

In various embodiments, a user associated with the entity and/or employer owning the rail asset may operate a user computing entity 30 to review the invoice (e.g., via the invoice tab 470 of the rail AM IUI 400) and/or the documents corresponding to the service event a step/operation 2742. In an example embodiment, the user may manually cause the documents corresponding to the service event to be stored in association with the rail asset (e.g., cause a link to the documents to be stored in the asset profile corresponding to the rail asset). In various embodiments, at step/operation 2746, the invoice may be vouchered for payment by the owner of the rail asset. At step/operation 2748, the charges that the lessee of the rail asset is responsible for are determined based at least in part on the lease and/or rider information/data associated with the rail asset and the lessee is billed for those charges (e.g., the lessee charges). The user computing entity 30 and/or server system 10 may determine and/or generate the lessee charges based at least in part on the invoice for the work performed by the shop and the lease and/or rider information/data associated with the rail asset and may provide the lessee charges to a user computing entity 30 associated with a user associated with the entity and/or employer operating and/or controlling the operation of the rail asset.

In various embodiments, based at least in part on the time the status of the rail asset was “in shop” and the lease and/or rider information/data associated with the rail asset, the server system 10 may determine whether and/or what rent abatement is owed to the lessee of the rail asset. An abatement flag, abatement record, and/or an abatement amount may be added to invoice information/data (e.g., stored by the server system 10 and/or accessible to the server system 10) corresponding to the billing cycle when the rail asset was in the shop.

In various embodiments, when the invoice is received by the server system 10, the server system 10 may cause the status of the BRC to be updated to “pending payment.” If a service event is generated but not completed (e.g., is canceled), the status of the service event is updated to “canceled.” Once the invoice for the service performed by the shop is vouchered (e.g., when the invoice for each shop corresponding to the service event is vouchered), the status of the service event is updated to “completed” and the shop status of the service event is updated to “complete.” In an example embodiment, the shop status of the service event is updated to “complete” when at least on BRC corresponding to the service event is vouchered (e.g., has a status of “accepted” or “vouchered”) and any none vouchered BRCs of the service event have a status of “canceled,” the shop status field of the service event data object is updated to “complete.” This allows the Rail AM system to reconcile lease invoices versus a system generated expected case voucher to allow for management by exception and payment of matching records. For example, the Rail AM system accounts for rental abatement and partial month rent in its expected case generation. The rail AM system also reconciles vendors that invoice current month and those that use an advanced payment method.

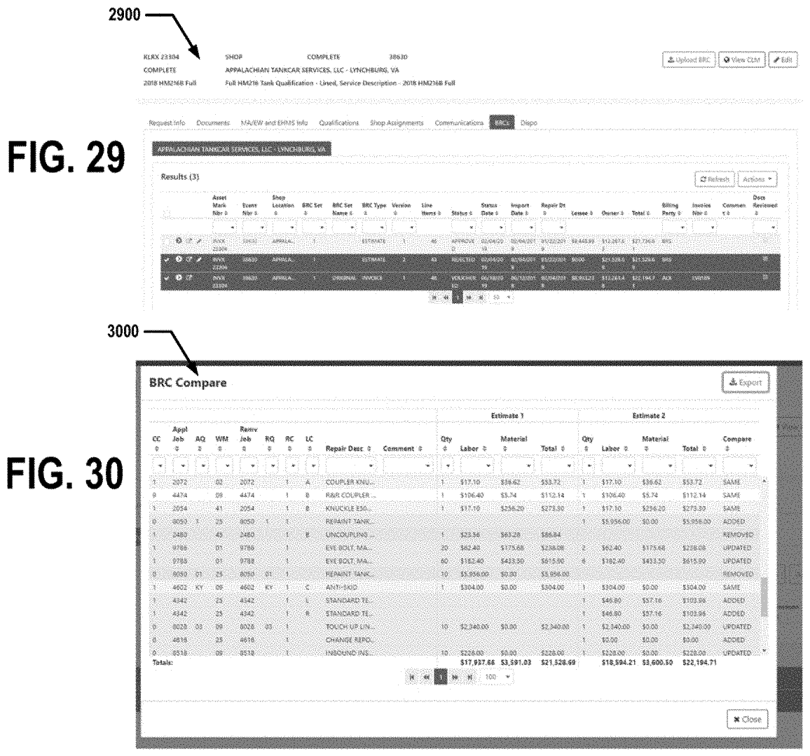

In various embodiments, the rail AM IUI 400 may provide the user with tools for reviewing BRCs and/or the like (e.g., such as at step/operation 2718). FIG. 29 provides an example view of a BRC sub-tab 2900 of a service tab 450 of a rail AM IUI 400. The user may filter BRCs corresponding to service events for rail assets owned, leased, and/or sub-leased by an entity and/or employer associated with the user. In various embodiments, the BRCs may be filtered based at least in part on various filtering criteria, such as rail asset type/equipment group, shop, fleet, owner, lessee, sub-lessee, type of service, one or more line items of the BRC, and/or the like. In an example embodiment, a user (e.g., operating a user computing entity 30) may select two or more BRCs to compare and select a selectable compare option from the actions menu. In various embodiments, the user computing entity 30 (and/or the server system 10) may generate a comparison of the two or more selected BRCs and provide the comparison via a BRC comparison tool of the rail AM IUI 400. For example, during a repair event, multiple revisions of estimate files (e.g., 500-byte files) and an invoice (e.g., 500-byte files) are received and must be reconciled to the original estimate. The rail AM system can store multiple BRC revisions of estimates from multiple repair facilities to a single event association. The rail AM system also reconciles to the individual estimate and employs a comparison tool for comparing multiple revisions of an estimate. The rail AM system compare the revisions, carries through approvals, highlights additions and changes, provides an area to approve changes or additions, and/or the like. The rail AM system provides a comparison tool for users to view two BRC revisions side-by-side. Rail AM highlights changes, additions, or subtractions to the file and carries approvals for unchanged lines forward to allow users to manage revisions by exception. FIG. 30 provides an example view of a BRC comparison tool 3000 comparing the two BRCs selected in FIG. 29. As can be seen in FIG. 30, the BRC comparison tool 3000 allows a user to easily compare corresponding line items of two or more BRCs which may have the same and/or different BRC statuses.

FIG. 31 provides an example view of a service dashboard 3100 that may be provided via the service tab 450 of an example embodiment of the rail AM IUI 400. The service dashboard may provide a user with the ability to search for service events (e.g., based at least in part on the maintenance analyst responsible for the service event, a lessee of the rail asset, fleet, commercial status of the rail asset, and/or the like). In an example embodiment, the service dashboard 3100 may further provide the user with an overview of information/data regarding service events for rail assets owned, leased, and/or sub-leased by an entity and/or employer associated with the user. For example, the service dashboard 3100 may provide information/data regarding upcoming estimated return dates (ERDs) for rail assets currently in the shop; the number of BRCs to be reviewed, accepted, and/or the like; the number of rail assets awaiting disposition instructions (Dispo); the number of rail assets that are ready to leave the shop; how long rail assets have been in the shop; and/or the like. Thus, the rail AM system can automatically use performance thresholds for events and report exceptions based at least in part on those performance thresholds in the service dashboard 3100. This allows for process exceptions to be clearly identified for users to take action—only reporting exceptions or near exceptions are displayed for ease of management.

### Exemplary Shop Tab/Shop Management

In various embodiments, the AM IUI 400 may comprise a shop tab 460. In various embodiments, the shop tab 460 may provide a user with access to information/data regarding one or more shops that perform service (e.g., repairs, maintenance, qualifications, inspections, and/or the like) of one or more types (e.g., equipment groups) of rail assets. For instance, a shop data store (e.g., shop database) may store a plurality of shop profiles, where each shop profile corresponds to a shop. In various embodiments, each shop profile comprises a unique shop identifier configured to identify the shop, a shop name, shop location (e.g., geolocation, such as latitude and longitude, street address, lines servicing the shop, location of shop on servicing lines, and/or the like), shop grade (e.g., a rating of the shop), repairing party identifier (which may correspond to the shop itself and/or one or more technicians employed at and/or associated with the shop), a standard point location code (SPLC) location of the shop, one or more agency marks, a station stencil (one per shop, may be “unknown”), address information/data (e.g., street, city, state/province, postal code/zip code, country, and/or the like), latitude and longitude coordinates of the shop (e.g., for distance (e.g., mileage, kilometrage) calculations, geo-tracking, and/or geo-fencing uses), asset (e.g., railcar) capacity (e.g., may include total capacity, under roof capacity, and/or on-track capacity), contact information/data, shop status (e.g., active or inactive), delivering railroad, switching schedule for each delivering railroad (e.g., may be a separate schedule for each day of the week), switch fee (e.g., a dollar amount), shop type (e.g., Mobile, Shop, Mini-shop, Scrap Facility, Storage Facility), capabilities (e.g., selected from a list; for each capability, a comments field and rating may be provide), and/or the like.

In various embodiments, one or more instances of contact information/data may be associated with each shop. An instance of contact information/data may include a first name and last name of the contact, an email address, office phone number, mobile phone number, title, roles (e.g., why would you contact this person), and/or the like. In an example embodiment, the list of capabilities that may be selected from include Boxcars, Tank Car, DOT 111A Retrofit, Covered Hopper, OpenTop Hopper, Gondola, Flat Car, Mobile Services, Light-Medium Repairs, Heavy Repairs, Wreck Repairs, M-1002 Tank Car Cert, M-214 Truck Rebuild Cert, M-1003 QA Cert, Non-Destructive Testing, Qualified Car Inspection, Food Grade Cleaning, Light-Medium Cleaning, Heavy Cleaning, Power Wash, Disposal, Exterior Painting—Full, Exterior Painting—T/U Only, Blasting Operations, Interior Coating, Interior Coating—T/U Only, and/or the like Car Shop Capability.

In various embodiments, a shop profile may comprise equipment groups serviced by the shop, labor rates, labor rates by asset (e.g., railcar) type (e.g., equipment group), mobile rate by asset (e.g., railcar) type (e.g., equipment group), date of last audit (e.g., pulled from shop audit data), storage fee per day (e.g., may be a tiered fee, such as $X after 30 days, $Y after 60 days, and/or the like), general comments regarding the shop (e.g., may include an under roof capacity, on track capacity, and/or the like), averages based at least in part on completed service events (e.g., based at least in part on a rolling window of 6 months, for example, of information/data and refreshed every week, for instance), such as average number of rail assets in the shop and/or average number of days in the shop for those rail assets, and/or the like.

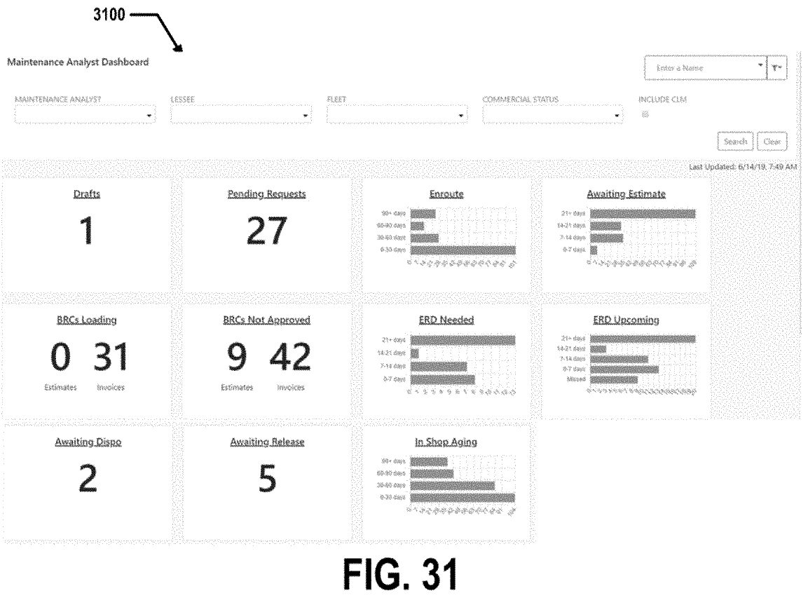

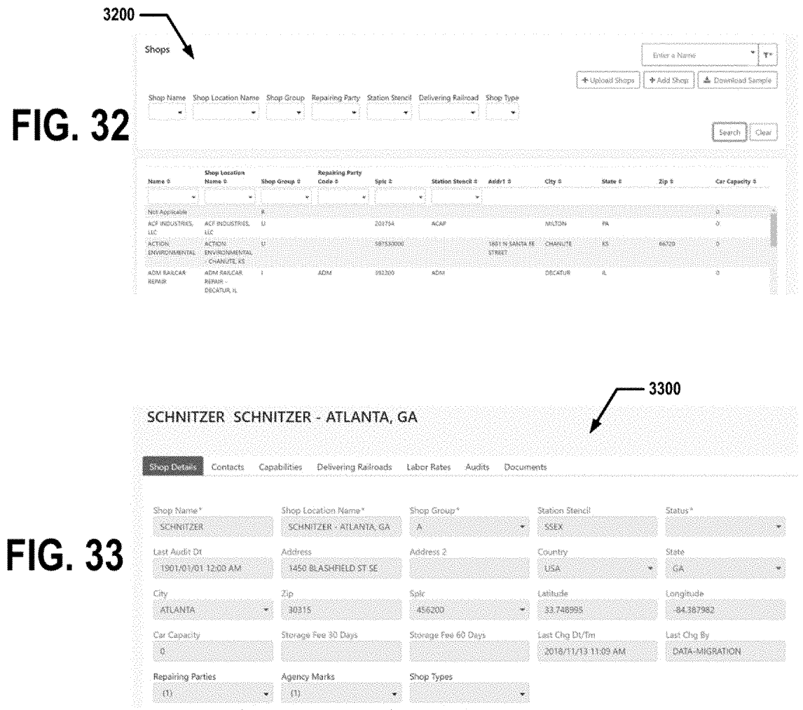

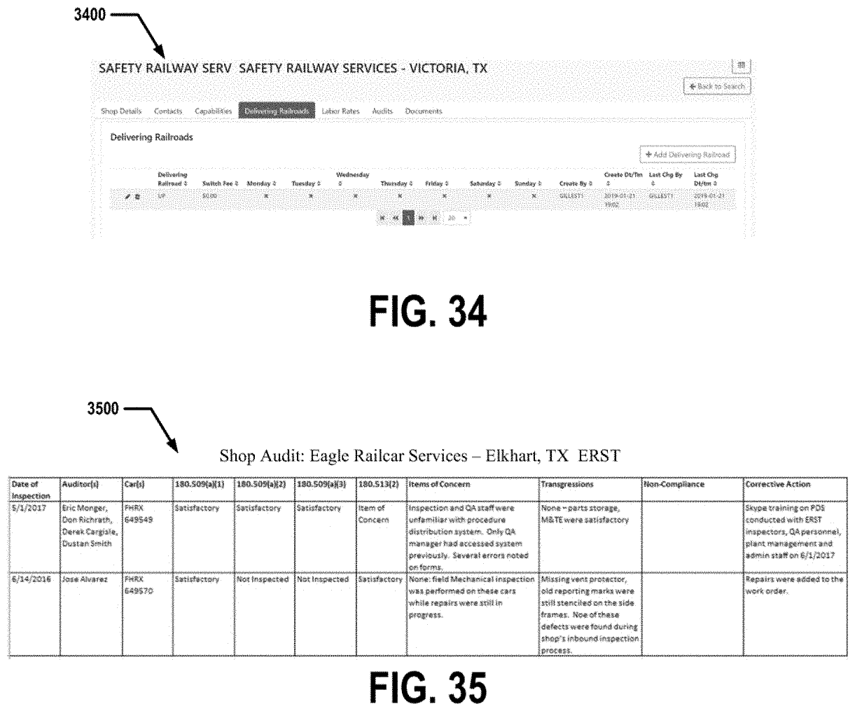

FIG. 32 provides an example view of a shop tab 3200. In various embodiments, the shop tab 3200 may provide a searchable directory of shops based at least in part on the shop profiles stored in the shop database, for example. For instance, the shop tab 3200 may provide a list of shops ordered based at least in part on one or more filter criteria (e.g., alphabetical, and/or the like). A user may search the list of shops based at least in part on various criteria and/or information/data from the shop profiles stored in the shop database. In various embodiments, a user (e.g., operating a user computing entity 30) may select a shop to from the searchable directory of shops and be provided with a shop detail sub-tab 3300, an example of which is shown in FIG. 33. For example, the shop detail view may provide shop information/data extracted from the corresponding shop profile. FIG. 34 illustrates an example delivering railroad sub-tab 3400 providing information/data regarding the delivering railroad, switch schedule, and switch fee for a particular shop. Thus, a user may access the shop tab 460 to access information/data related to various shops known to the rail AM system (e.g., due to information/data mining from previous BRCs, through manual information/data entry, and/or the like).

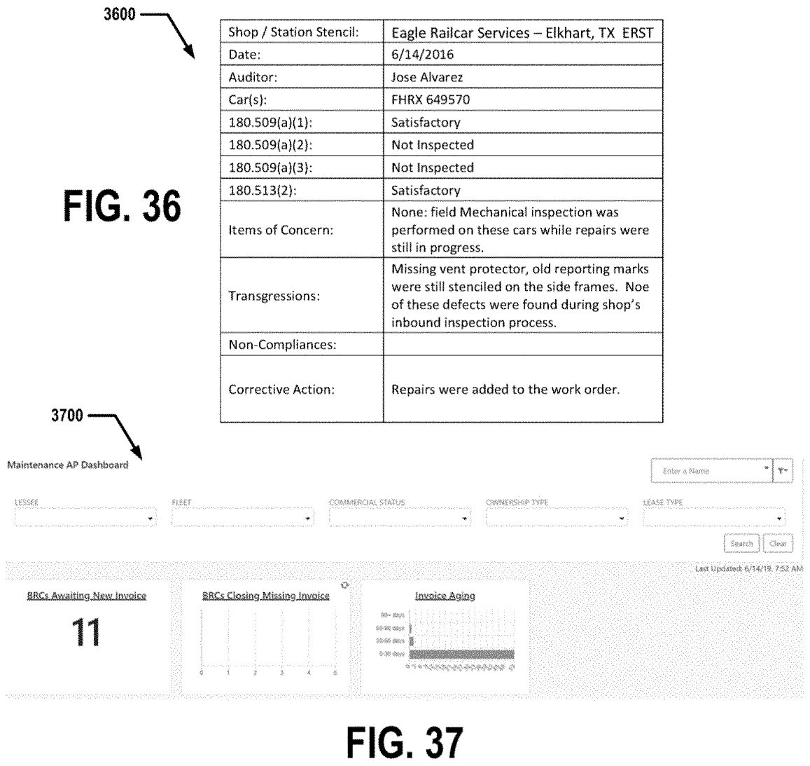

In various embodiments, shop audits may be performed, and shop audit information/data may be stored in association with one or more shop profiles (e.g., in the shop database). For instance, as shown in FIGS. 33 and 34, the shop tab 460 may include a shop audit sub-tab that may be selected from a shop detail sub-tab such that information/data corresponding to audits of the shop corresponding to the information/data of the shop detail sub-tab. In various embodiments, information/data corresponding to audits of the shop may be provided via a table with information/data corresponding to the most recent audit of the shop on top, for example. In an example embodiment, to provide the shop audit information/data corresponding to a particular shop, the server system 10 may filter the stored shop audit information/data based at least in part on the shop name and/or station stencil corresponding to the particular shop. Various audit information/data corresponding to a user-selected and/or provided shop may then be provided, for instance, as an audit summary table. For example, FIG. 35 provides an example view of an audit summary table 3500. If a user (e.g., operating a user computing entity 30) selects a particular audit from the audit summary table 3500, the rail AM IUI 400 may provide an audit report 3600, an example of which is shown in FIG. 36. In various embodiments, a user corresponding to a user profile having the appropriate permissions may create, maintain, view, delete and/or attach documents to one or more audits from the shop audit sub-tab of the rail AM IUI 400.

### Exemplary Invoice Tab/Invoice Management

In various embodiments, the rail AM IUI 400 comprises an invoice tab 470. FIG. 37 provides an example landing page 3700 of an invoice tab 470, according to an example embodiment. In an example embodiment, the landing page 3700 of the invoice tab 470 may provide a summary of current invoicing actions, alerts regarding urgent actions required, notifications regarding tasks that may require the user's attention, and/or the like. For instance, the landing page 3700 of the invoice tab 470 may provide summary information/data regarding the number of BRCs waiting to be invoiced, invoice aging, and/or the like. In various embodiments, the landing page 3700 of the invoice tab 470 may enable the user to search and/or query invoices (e.g., stored in an invoice database in memory 110, 115 of the server system 10 and/or accessible to the server system 10) based at least in part on various criteria, such as lessee, fleet, commercial status, ownership type, lease type, and/or the like, for example.

In various embodiments, the rail AM system may be configured to generate and/or provide invoices for services performed by shops, inspection fees for the inspection of rail assets, and rent for the lease and/or sub-lease of rail assets. In an example embodiment, the rail AM system may be configured to present an invoice to the payee of the invoice and enable a user corresponding to a user profile having appropriate permissions to voucher the invoice.

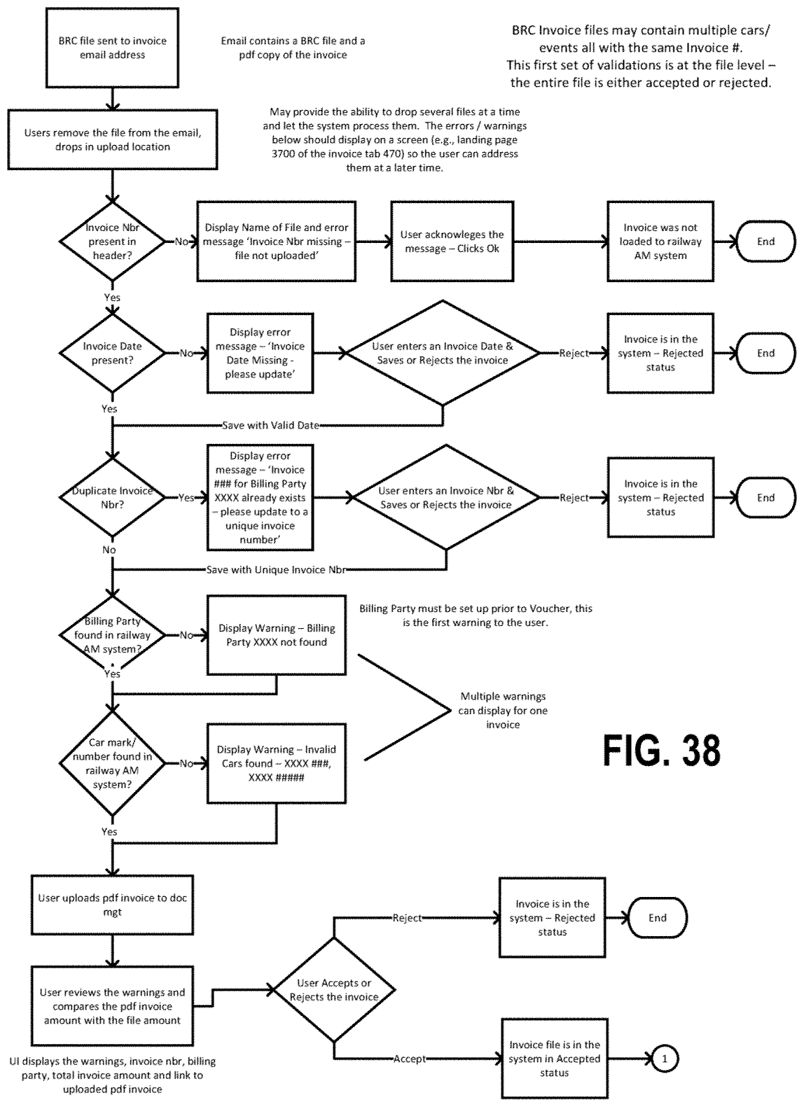

FIGS. 38-43 provide various flowcharts, status flow diagrams, and/or the like describing example process performed by the server system 10 (e.g., in coordination with indications of user input received via the user computing entity 30) to process invoices received from a shop (e.g., for performing one or more services on one or more rail assets). In an example embodiment, the first step of processing the invoice received from the shop includes uploading the invoice to the rail AM system (e.g., if the shop did not provide the invoice via the rail AM system) and accepting (or rejecting) the invoice as whole based at least in part on various criteria. For instance, the first step may include confirming that the invoice has a valid invoice number, the invoice has a valid invoice date, the invoice is not a duplicate, the billing party is known to the rail AM system, the invoice corresponds to one or more rail assets known to the rail AM system, and/or the like, as described in FIG. 38.

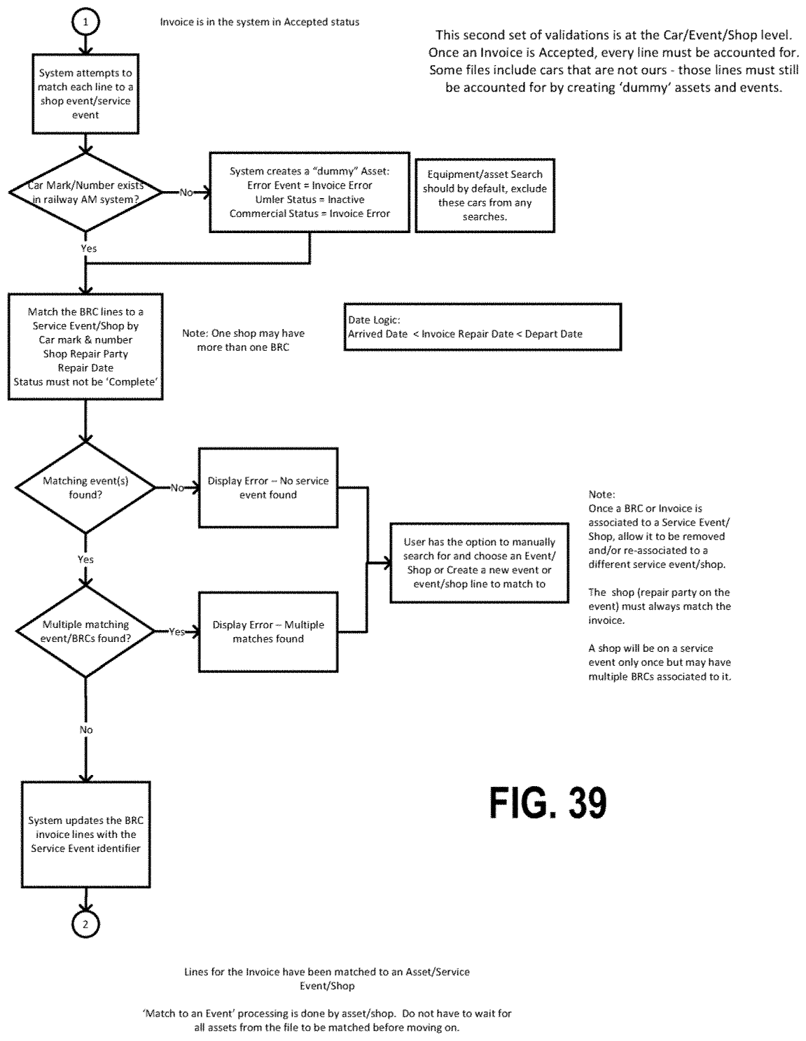

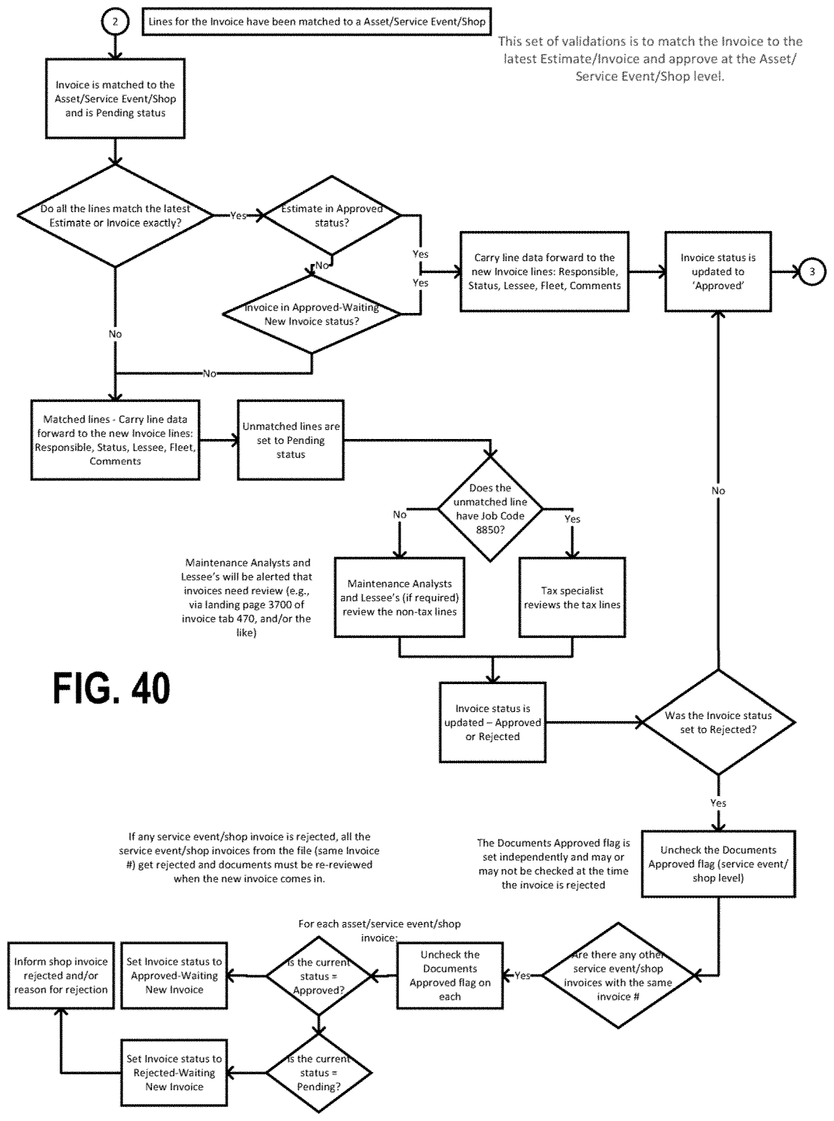

As described in FIG. 39, a second step of processing an invoice received from a shop for servicing one or more rail assets includes matching the lines of the invoice to service events, rail assets, and shops known to the rail AM system, in an example embodiment. For example, a line of an invoice may be matched to a line of a BRC. In an example embodiment, as described in FIG. 40, in a third step, the lines of the invoice may be compared one a line by line basis to a corresponding estimate based at least in part on the rail asset, service event, shop, and/or BRC and it may be determined if the invoice line amount matches that of the corresponding estimate line. For invoice lines that do not match an approved corresponding estimate line, a user corresponding to a user profile having the appropriate permissions may review the non-matching lines of the invoice and accept or reject the non-matching lines of the invoice on a line by line basis.

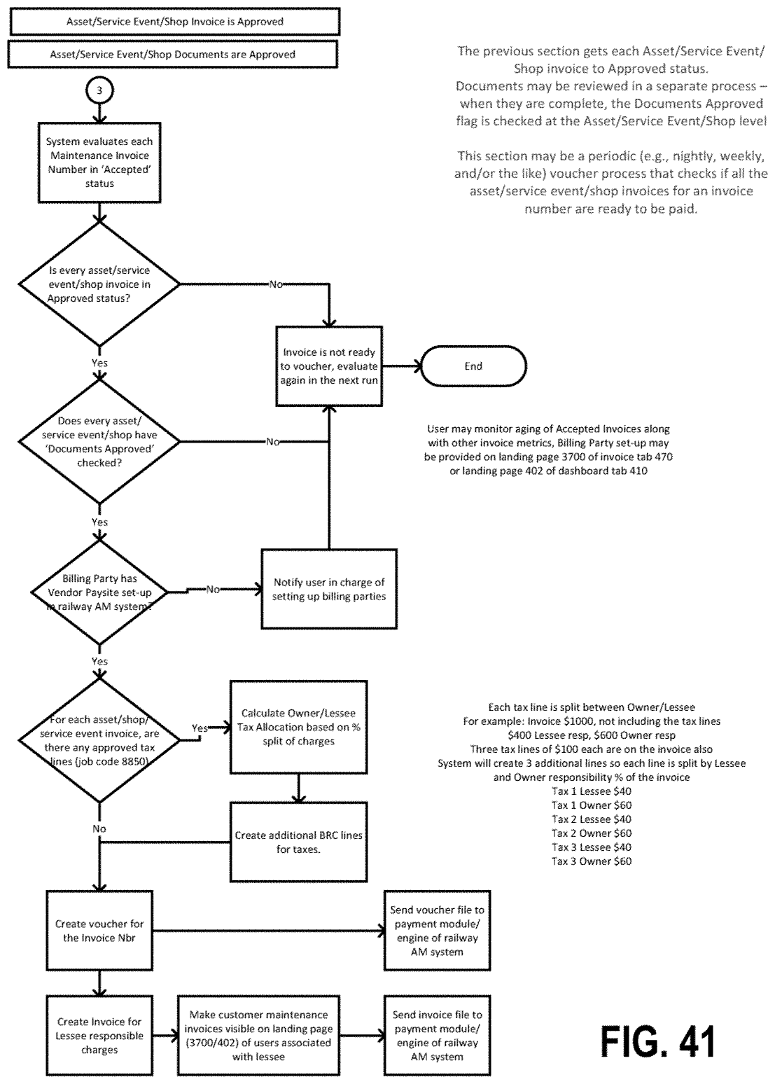

In a fourth step, according to an example embodiment and as described in FIG. 41, for invoices that have been accepted, have the associated documents approved, having billing parties that are known and/or set up with the rail AM system billing platform, and/or the like, the invoices may be vouchered and provided to a payment module, engine, and/or the like of the rail AM system. In an example embodiment, the payment module, engine, and/or the like is external to the rail AM system. For instance, the rail AM system may communicate with the payment module, engine, and/or the like via an application programming interface (API). In various embodiments, the rail AM system may generate and provide lessee invoices corresponding to a portion of a service invoice that the lessee is responsible for (e.g., based at least in part on lease and/or rider information/data corresponding to the rail asset of the service event invoiced).

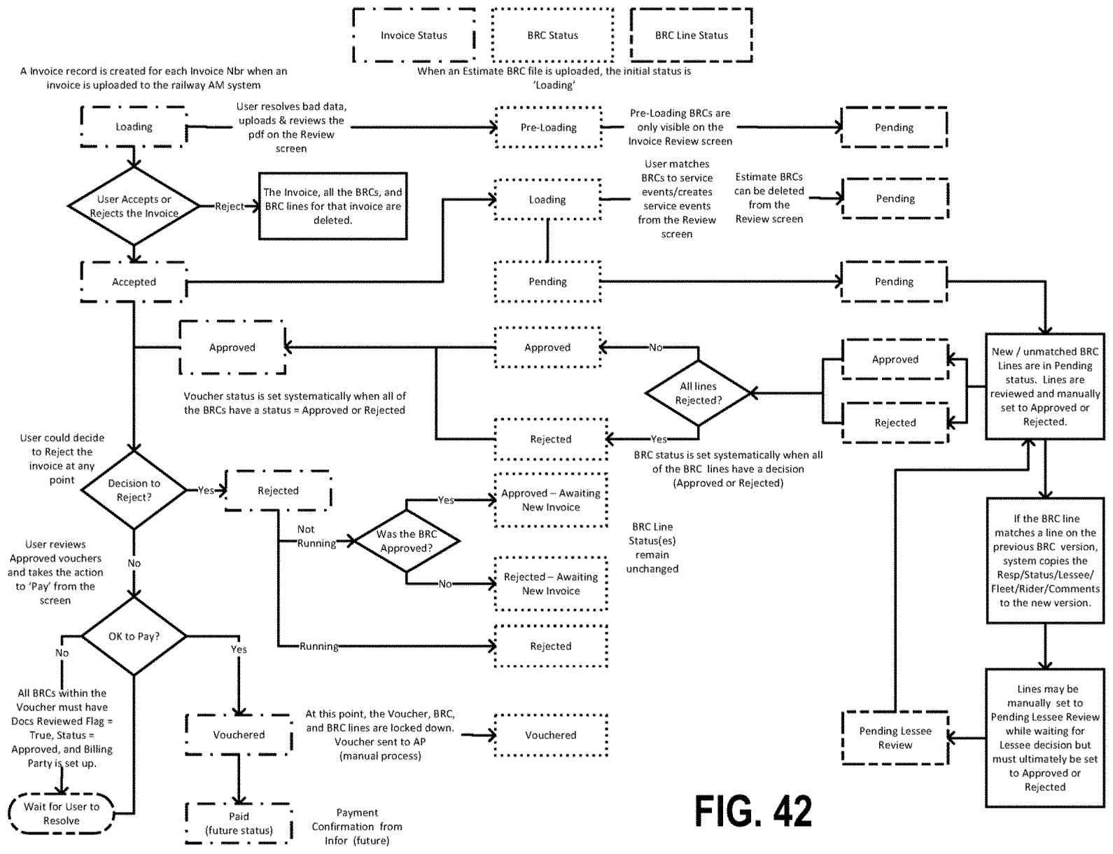

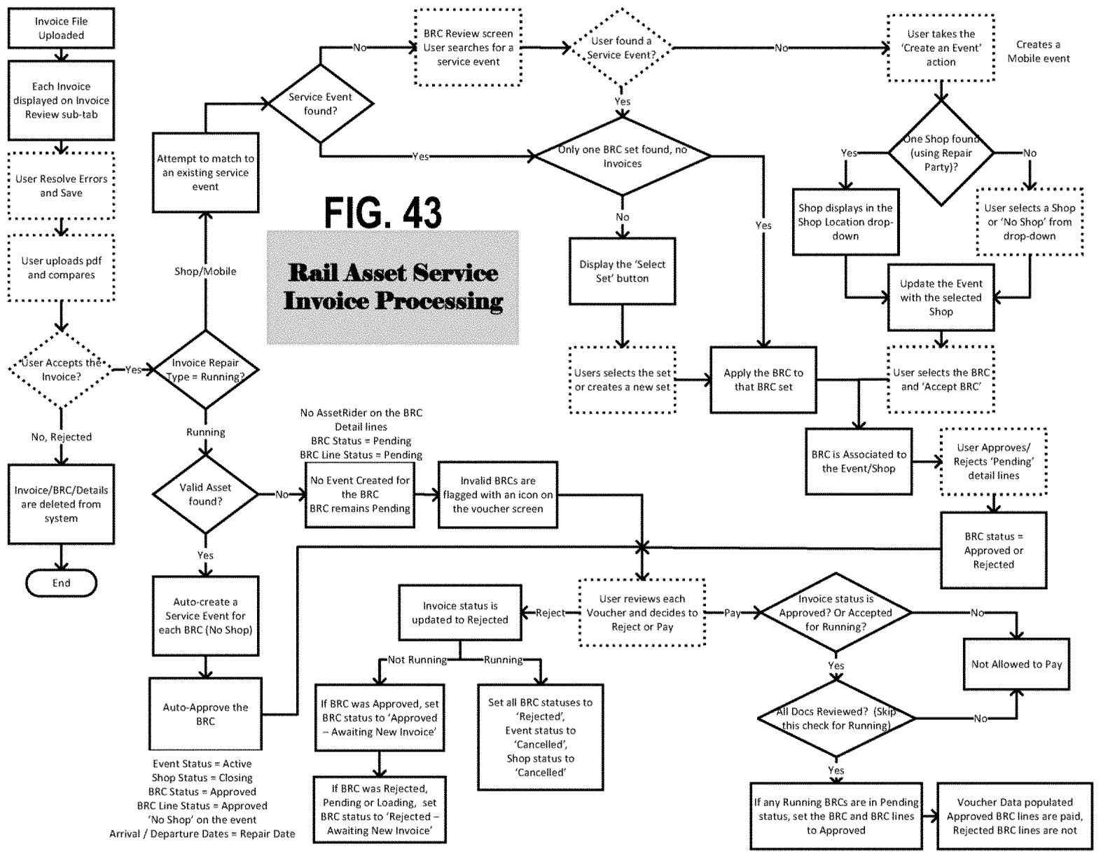

FIG. 42 provides a status flow diagram illustrating the various stages of statuses for invoices, BRCs, and lines of BRCs. FIG. 43 provides a flowchart describing an example process for rail asset service invoice processing where lines of an invoice are matched to a BRC, rail asset, shop, service event, and/or the like during the invoice processing.

In various embodiments, the invoice tab 470 may also provide information/data and/or tools for invoicing rent due to a rail asset owner and/or lessor for the leasing and/or sub-leasing of rail assets. In an example embodiment, an invoice may be received from a rail asset owner and/or lessor for rental of the rail asset for a particular month. In an example embodiment, an invoice may be received via email and/or other delivery methods and include a list of rail assets with associated charges. In an example embodiment, a user associated with the entity and/or employer receiving the invoice may upload the invoice (e.g., via the document manager of the rail AM system.

In an example embodiment, invoices uploaded to the rail AM system are in a standard format. In an example embodiment, the standard format may be an excel or .csv format and/or template. In an example embodiment, the template may include columns and/or rows identifying and/or providing a lessor identifier, a customer invoice number, invoice month, asset mark, asset number, charge type, start date (e.g., first day of the billing period/month and/or start date during the billing period/month that rental of the rail asset began), end date (e.g., last day of the billing period/month and/or end date during the billing period/month that rental of the rail asset ended), number of days in the billing period (e.g., between the start date and end date), charge amount (positive or negative), a lessor reference number, a rider identifier, and/or the like. In an example embodiment, the user uploading the invoice may fix missing information/data and/or formatting issues such that the invoice is in the appropriate format when uploaded to the rail AM system. For example, the template may provide for only one month per line such that any line that span more than one month are split into multiple lines.

In various embodiments, one or more validity checks may be performed by the rail AM system. In various embodiments, when the user uploads the invoice to the rail AM system, the user selects the lessor from a list of lessors known to the rail AM system to ensure that the invoice is valid (e.g., is provided by a valid lessor). In various embodiments, the rail AM system may confirm the number of days in the billing period, populate and/or validate the rider identifier associated with one or more line items, confirm that invoices and/or line items are not duplicated, and/or perform other validity checks. In various embodiments, the user may be able to edit the rider identifier and charge type of one or more lines.

In various embodiments, a user (e.g., operating a user computing entity 30) may review one or more invoices corresponding to lease of one or more rail assets (e.g., via the invoice tab 470 of the rail AM IUI 400) by selecting a lessor from a list of parties, selecting a lessee from a list of parties, selecting a lease from a lease list that is dependent on a selected lessor/lessee, selecting a rider from a rider list that is dependent on a selected lessor/lessee/lease, a billing month, and/or the like.

In various embodiments, adjustments may be made to the rent of the rail asset during the billing period. For instance, if the rail asset was not available to the lessee for the entire period between the start date and the end date (e.g., the rail asset was in the shop, the rail asset was not yet delivered to the lessee, and/or the like based at least in part on the corresponding lease and/or rider(s)), the rent due for that billing period may be adjusted. In an example embodiment, rent adjustments (e.g., adjustment records) are written to an invoice database (e.g., stored by the server system 10 and/or accessible to the server system 10) as they happen/occur and marked as “pending.” For example, any change to the on-lease or off-lease date for a rail asset may be captured including impact to the rent, month the impact applies to, the corresponding rider, rate, status, and/or the like. In example embodiment, if multiple changes are made to on-lease/off-lease dates in the same billing period, the previous “pending” rent adjustment records are removed and replaced with new adjustment records.

In an example embodiment, when an off-lease date of a rail asset (according to an asset rider naming the rail asset) is occurs in the middle of a billing period (e.g., not on the first or last day of the billing period), credit may be given from the off-lease date to the end of the billing period and the full current billing period is billed. In an example embodiment, when the off-lease date is in the prior billing period, credit may be given from the off-lease date to the end of the prior billing period and the current billing period is not billed. If the off-lease date is more than one billing period back (e.g., the off-lease date was in April and the current month is July for monthly billing periods), credit may be given from the off-lease date to the end of the billing period that the off-lease date occurred in, credit is given for full billing periods between the billing period when the rail asset went off-lease and the current billing period, and the current billing period is not billed. In an example embodiment, when the off-lease date is in a future billing period, the current billing period is billed.

In an example embodiment, when a rail asset on-lease date (e.g., according to a corresponding asset rider) is during a current billing period, credit may be given from the beginning of the billing period to the day before the on-lease date and the full current billing period may be billed. In an example embodiment, if the on-lease date is in the prior billing period, rent may be billed from the on-lease date to the end of the prior billing period and the full current billing period may be billed. In an example embodiment, when the on-lease date is more than one billing period back, rent may be billed form the on-lease date to the end of the billing period including the on-lease date, rent may be billed in full for the billing periods from the billing period through the current billing period. In an example embodiment, when the on-lease date is in a future billing period, rent is not billed for the rail asset for the current billing period.

In various embodiments, adjustments to rent for a rail asset for a billing period may be made based at least in part on service events corresponding to the rail asset. In various embodiments, the adjustments are governed by the lease and/or riders corresponding to the lease of the rail asset. In an example embodiment, rent abatement (e.g., due to a rail asset being unavailable to the lessee due to, for instance, the rail asset being in shop) may be manually added and managed in the billing review screen, in an example embodiment. For instance, an abatement record may be accessed from the invoice database to determine the rent abatement due corresponding to a rail asset during a billing period. In an example embodiment, an abatement record may be added and/or modified to an approved state to give credit for a rent abatement during a previous billing period. In an example embodiment, an abatement record may be added and/or modified in a suspend state to show the accruing abatement for the current billing period. In an example embodiment, a service event data object may track the abatement due for a service event for a rail asset. For example, when the rail asset status is updated in the service event data object, an abatement record may be added and/or modified in the invoice database to track the accrual of rent abatement due to the rail asset being in shop.

In various embodiments, an adjustments sub-tab of the invoice tab 470 may enable users (e.g., operating a user computing entity 30 and corresponding to user profiles having appropriate permissions) may manually add adjustment records to the invoice database. For instance, the adjustment records may be made to account for a payment that needs to be made or an amount that should be received that is not systemically generated (e.g., abatement, lump refunds received, payments made, and/or the like). In an example embodiment, an adjustment record may have a status, such as approved, suspended, pending, non-voucher (e.g., for refunds or payments that do not have to go through the voucher/invoice process but that need to be accounted for at the rail asset level). In various embodiments, adjustment records may include a date that the adjustment record was generated, an asset identifier, an asset mark/number, an adjustment type (e.g., rent, rent adjust, abatement, abatement adjustment, distance, miscellaneous, and/or the like), lease (e.g., selected from a list dependent on the rail asset), rider (e.g., selected from a list dependent on the lease and/or rail asset), on-lease/off-lease dates (e.g., pulled from the selected rider), adjustment amount (e.g., entered as a lump sum or calculated based at least in part on rate, days of adjustment, and/or the like).

In an example embodiment, when a lease invoice corresponding to rent of one or more rail assets is received, the invoice may be processed in a manner similar to a service invoice. For example, each line of the lease invoice may be matched to a rail asset, billing period, rider, and/or the like. In an example embodiment, an amount of the invoice line may be matched and/or compared to an expected amount (e.g., based at least in part on the rail asset, rider, billing period, and/or the like). If the expected amount and the invoice line amount match (e.g., are within a predefined dollar value of one another), the line is considered matched. If the expected amount and the invoice line amount do not match (e.g., are not within the predefined dollar value of one another), the line is considered unmatched, marked as rejected, and a user may be notified of the unmatched/rejected status of the line. A user (e.g., operating a user computing entity 30) may update one or more sources of information/data used to determine the expected amount (e.g., such that the expected amount and the line amount match) and/or may override the rejected status of the line.

In an example embodiment, the invoice tab 470 may be used to generate, determine, and/or pay ad valorem taxes, use taxes, fuel taxes, and/or the like to one or more entities/jurisdictions (e.g., states, counties, cities, and/or the like) for the transportation of particular goods (e.g., within a rail asset) though a jurisdiction. For example, the system computing entity 10 may periodically (e.g., once a week, once a month, once a quarter, once a year) leverage the travel information/data for the rail asset and determine the number of miles the rail asset traveled through various jurisdictions during the corresponding time period. The determined number of miles the rail asset traveled through a particular jurisdiction may then be used to determine the ad valorem taxes, use taxes, fuel taxes, and/or the like due. The rail AM system may be configured to provide visibility regarding the ad valorem taxes, use taxes, fuel taxes, and/or the like due via the rail AM IUI 400, track the ad valorem taxes, use taxes, fuel taxes, and/or the like due for use in paying such taxes, enable a user to initiate payment of the ad valorem taxes due, and/or the like.

Thus, in various embodiments, invoices for service events may be processed (e.g., validated; matched to known service events, rail assets, and/or the like; etc.), invoices for leasing of rail assets may be processed (e.g., validated; matched to known rail assets, leases/riders, and/or the like; etc.), invoices for leased rail assets may be generated, adjustments to invoices (invoices for leasing of rail assets and/or for leased rail assets) may be tracked, determined, and/or the like. In various embodiments, invoices that have been processed and accepted/approved may be vouchered for payment. In various embodiments, the invoice tab 470 provides visibility and tools for user functions corresponding to the generating, processing, vouchering, and payment of invoices.

### Exemplary Compliance Tab/Compliance Management

In various embodiments, the rail AM IUI 400 includes a compliance tab 480. In various embodiments, the compliance tab 480 is configured to assist in the monitoring, tracking, and/or the like of inspections of rail assets and/or other requirements for complying with corresponding regulations. In various embodiments, the regulations corresponding to a rail asset are dependent on the equipment group/type of the rail asset. For instance, tank cars have different compliance considerations than boxcars. In various embodiments, the rail AM system is configured to track compliance events (e.g., completed inspections, upcoming inspections, services performed to comply with regulations, and/or the like) for each rail asset based at least in part on the equipment group/type associated with the rail asset (e.g., based at least in part on the asset profile corresponding to the rail asset). In various embodiments, the rail AM system is configured to provide document management and/or storage for documents corresponding to compliance events for one or more rail assets. For example, the rail AM system may store prior inspection certificates, documents needed for completing future compliance events, and/or the like.

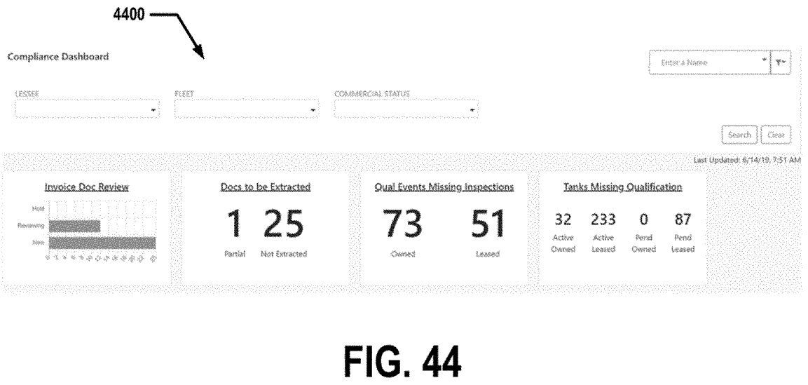

FIG. 44 provides an example view of a compliance tab 480 landing page 4400. For instance, the landing page 4400 may enable a user (e.g., operating a user computing entity 30) to search compliance events based at least in part on various criteria, such as, for example, lessee, fleet, commercial status, and/or the like. In an example embodiment, the landing page 4400 of the compliance tab 480 may provide a user with information/data regarding a number of rail assets currently undergoing compliance checks (e.g., qualifications, inspections, and/or the like), a number of rail assets for which compliance checks are due in the near future (e.g., next month, next quarter, within six months, next year, two years out, and/or the like), if any rail assets are overdue for compliance checks, and/or the like.

In various embodiments, for each inspection and/or qualification test of a rail asset, a compliance event is generated, and a corresponding compliance event data object is generated and stored (e.g., in a compliance database). In various embodiments, a compliance event data object includes information/data identifying the rail asset (e.g., asset identifier, asset mark/number, and/or the like), an inspection/qualification test date, and other information/data corresponding to the inspection and/or qualification test. For instance, a compliance event data object may include an inspection/qualification test name (e.g., which may be selected from a list of inspections/qualification tests), an inspection/qualification test date done, an inspection/qualification test due date, a shop or inspector that performed the inspection/qualification test, a shop/inspector SPLC indicating the location where the inspection/qualification test was performed, a compliance event identifier, links to one or more documents corresponding to the compliance event, comments (e.g., a free form text field), inspection/qualification test status (e.g., active, expired, pending), asset equipment group/type, and/or the like. In an example embodiment, a compliance event is a service event within the rail AM system.

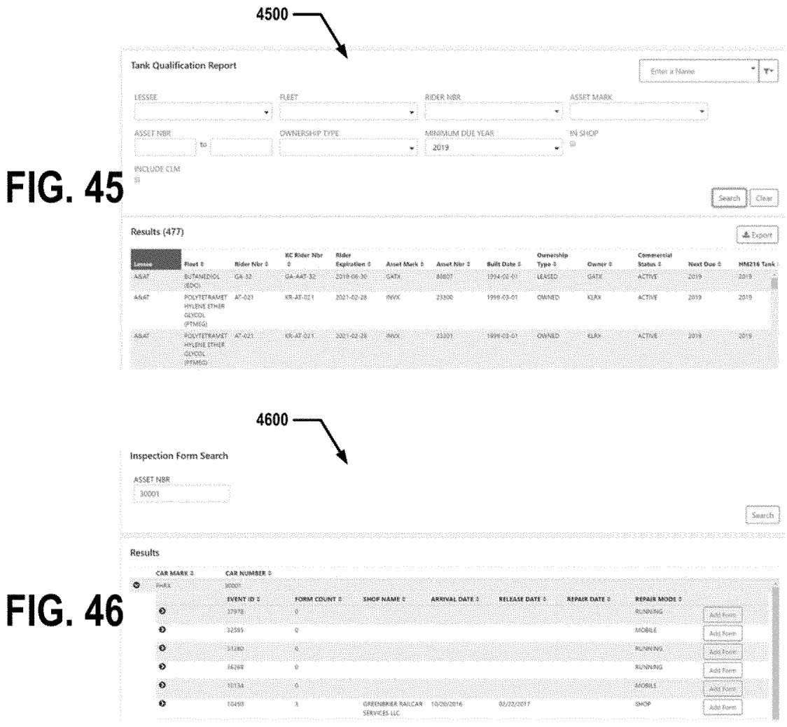

FIG. 45 illustrates an example tank qualification report 4500 listing information/data corresponding to compliance events relating to tank cars. In various embodiments, the qualification reports may be filtered based at least in part on various criteria, such as, for example, lessee, fleet, rider, asset mark/number, asset identifier, ownership type, year due, and/or the like. In one embodiment, this allows rail asset component owners who are regulatorily required to demonstrate that components will perform at a design level of service reliability to provide the relevant information/data, providing an industry leading link between various data types influencing component reliability, for example.

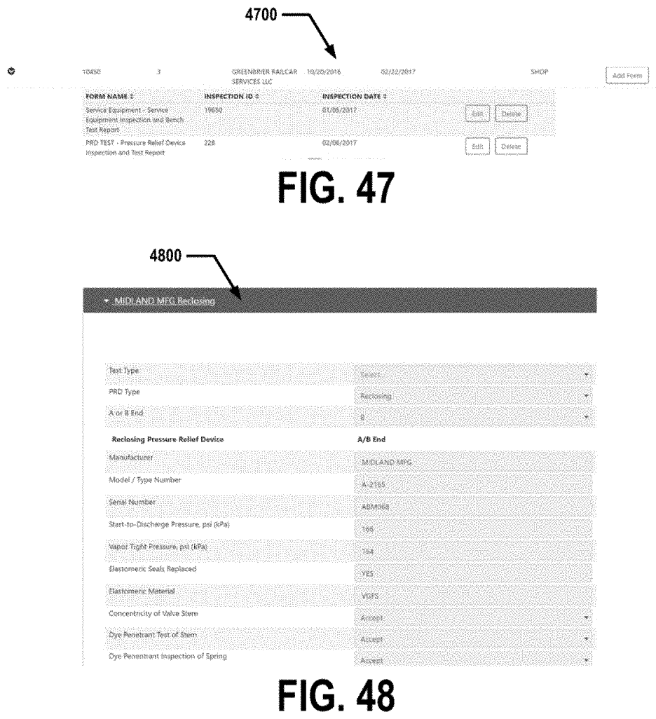

In various embodiments, the rail AM system may store compliance forms corresponding to various inspection and/or qualification events. For instance, after a qualification test, a particular form may need to be filed with the appropriate entity to maintain registration of the rail asset and/or to update entity records indicating that the rail asset has passed the qualification test. FIG. 46 illustrates an example view of a compliance form list 4600. For example, a user (e.g., operating a user computing entity 30) may access a form from the compliance form list 4600, complete the form, file the form with an appropriate entity, store the completed form in the document database, and/or the like. For instance, FIG. 47 illustrates an example view of a list of completed forms 4700 stored in the document database. In an example embodiment, one or more fields of a form may be automatically filled based at least in part on information/data extracted from a compliance event data object corresponding to the compliance event. In an example embodiment, one or more fields of the form may be editable by a user (e.g., operating a user computing entity 30 and corresponding to a user profile having appropriate permissions). FIG. 48 illustrates an example form 4800 that has been pre-filled based at least in part on information/data extracted from a compliance event data object corresponding to an inspection of the rail asset.

Thus, the compliance tab 480 provides visibility of upcoming compliance events and provides information/data regarding current, past, and upcoming compliance events, wherein a compliance event may be an event (e.g., possibly a service event) that corresponds to maintaining a rail asset in compliance with applicable regulations.

### Exemplary Document Management

In various embodiments, the rail AM system is configured to manage documents relating to one or more rail assets. For example, the server system 10 may store (e.g., in memory 110, 115) and/or have access to a document database storing the managed documents. The documents may correspond to the mechanical integrity of rail assets, inspection reports, qualification test results, compliance forms, services performed on the rail assets, information/data (e.g., specifications, drawings, and/or the like) regarding how the rail asset was original manufactured and/or fabricated, information/data (e.g., specifications, drawings, and/or the like) regarding refabrication, specialization, customization and/or the like of the rail asset, and/or the other documents corresponding to one or more rail assets. In various embodiments, multiple versions of a document may be stored. Thus, the rail AM system is configured to track superseded revisions of such documentation, allowing users to toggle between currently applicable and all specification documentation history. In various embodiments, the rail AM IUI 400 may be configured to provide access to managed documents to users (e.g., operating user computing entities 30) in accordance permissions associated with the corresponding user profiles. In various embodiments, an asset profile, service event data object, compliance event data object, lease, rider, and/or the like may comprise links to one or more corresponding and/or related documents. In an example embodiment, a document may be stored in association with metadata identifying a corresponding rail asset (e.g., asset identifier, asset mark/number), service event (e.g., service event identifier), compliance event (e.g., compliance event identifier), lease (e.g., lease identifier), rider (e.g., rider identifier), a document type, document sup-type, document version, document property and corresponding property value, document name, and/or the like. In an example embodiment, the metadata stored in association with the documents may be used to enable a user to search and/or query the documents based at least in part on various criteria (e.g., rail asset, lease, rider, document type, document name, and/or the like). Further, the rail AM system provides document storage for all specifications and event-level documentation associated with a rail asset.

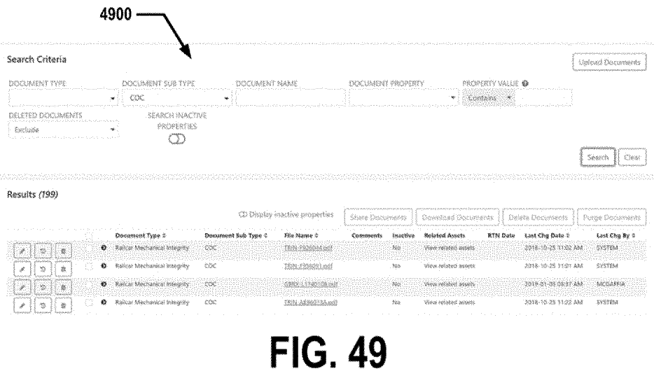

FIG. 49 provides an example view of a document management screen 4900 that may be provided via the rail AM IUI 400, in an example embodiment. For instance, a user (e.g., operating a user computing entity 30) may search the managed documents (e.g., the document database) based at least in part on various criteria, such as, for example, document type, document sub-type, document name, document property and corresponding property value, rail asset, and/or the like.

### Technical Advantages

Various embodiments provide a variety of technical improvements. For instance, various embodiments provide a technical solution to the technical problem of managing, controlling access to, recording, and/or the like information/data corresponding to a rail asset, leases and/or riders corresponding to a rail asset, service events for rail asset, compliance events for a rail asset, documents corresponding to a rail asset, invoices for service events and/or rent of a rail asset, and/or the like. For instance, various embodiments ensure important documents corresponding to a rail asset are available and that the most recent and/or up-to-date version of the documents are available for users needing access to the documents. For example, various embodiments provide automated and/or simplified process flows for tasks that previously took many hours of man time while increasing visibility of key pieces of information/data to increase the efficiency with which fleets of rail assets are managed. Thus, various embodiments provide technical improvements to the field of rail asset management, process flow management, information/data and/or document management, and/or the like.

For example, various embodiments provide a technical solution to the technical problem of filtering communications and information/data and/or documents provided by such communications into appropriate storage locations (e.g., appropriate databases, sub-databases, and/or database portions) to enable the provision of an IUI, such as the rail AM IUI, in a time efficient manner. For example, filtering of the electronic communications and information/data and/or documents provided by such communications enables the accessing and providing of information/data via the rail AM IUI in a manner that reduces the latency of the information/data being provided to a user via the IUI, streamlines user interaction with the information/data, and decreases the computational resources required for providing the IUI. Various embodiments of the present disclosure therefore provide technical improvements that lead to improved user experience of the rail AM IUI.

### V. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising at least one processor, at least one memory storing computer program code corresponding to a rail asset management system, and a communications interface, the at least one memory and the computer program code configured to, with the processor, cause the apparatus to at least:
receive an electronic communication comprising information corresponding to a rail asset;
determine an asset identifier configured to identify the rail asset based at least in part on content of the electronic communication;
determine a category corresponding to the information based at least in part on content of the electronic communication;
identify, based at least in part on the category, a database corresponding to the information;
generate or update a database record stored in the identified database based at least in part on the information and associated with the asset identifier; and
provide an interactive user interface (IUI) configured to enable user interaction with the generated or updated database record, the IUI provided such that display of the IUI is caused via a display.

2. The apparatus of claim 1, wherein the electronic communication comprises a billing repair card document corresponding to at least one service event for the rail asset, the IUI comprises a service event tab configured to provide information regarding one or more service events for the rail asset, and the at least one memory and the computer program code are further configured to, with the processor, cause the apparatus to at least:
determine whether the billing repair card document comprises a service event identifier configured to identify the at least one service event;
responsive to determining that the billing repair card does not comprise the service event identifier:
query a service event database storing a plurality of service event data objects to identify a service event data object corresponding to the at least one service event based at least in part on at least one of (a) one or more data fields of the billing repair card document or (b) metadata associated with the billing repair card,
extract the service event identifier from the service event data object, and
associate the service event identifier with the billing repair card document;
cause the service event tab of the IUI to be updated based at least in part on content of the billing repair card document; and
provide the service event tab of the IUI such that the service event tab of the IUI is displayed via the display.

3. The apparatus of claim 2, wherein the at least one memory and the computer program code are further configured to, with the processor, cause the apparatus to at least:
determine whether a previous billing repair card document corresponding to the service event has been processed;
responsive to determining that the previous billing repair card document has been processed, identify one or more line items of the billing repair card document that differ from the previous billing repair card document;
update a comparison page of the IUI such that the comparison page provides an indication the one or more line items of the billing repair card document that differ from the previous billing repair card document; and
provide the comparison page such that the comparison page is displayed via the display.

4. The apparatus of claim 2, wherein the at least one memory and the computer program code are further configured to, with the processor, cause the apparatus to at least:
based at least in part on at least one of lease information or rider information stored in association with the asset, determine whether a lessee of the rail asset should receive rent abatement corresponding to the service event; and
responsive to determining that the lessee of the at least one rail asset should receive rent abatement corresponding to the service event, generate and store an abatement record in association with invoice information associated with the at least one rail asset for a billing cycle corresponding to the service event, wherein the abatement record is generated based at least in part on at least one of (a) a railway asset status associated with the rail asset or (b) an amount of time the rail asset was associated with the railway asset status of in shop.

5. The apparatus of claim 4, wherein the at least one memory and the computer program code are further configured to, with the processor, cause the apparatus to at least:
update an invoice tab of the IUI to provide at least some of the information stored in the abatement record; and
provide the invoice tab such that the invoice tab is displayed via the display.

6. The apparatus of claim 2, wherein the at least one memory and the computer program code are further configured to, with the processor, cause the apparatus to at least:
determine whether the rail asset is associated with a program of a plurality of programs;
responsive to determining that the rail asset is associated with the program, identify one or more services corresponding to the program;
determine whether a facility associated with the service event is capable of performing at least one of the one or more services; and
responsive to determining that the facility is capable of performing the at least one of the one or more services, generate and provide a request for the facility to at least one of (a) provide an estimate for performing or (b) perform the at least one of the one or more services.

7. The apparatus of claim 2, wherein the service tab of the IUI is configured to be interacted with by a user such that an indication of user input approving or rejecting one or more line items of the billing repair card document and the at least one memory and the computer program code are further configured to, with the processor, cause the apparatus to at least, responsive to receiving the indication, update a status associated with the one or more line items based at least in part on the indication.

8. The apparatus of claim 1, wherein the electronic communication is received via an application programming interface (API).

9. The apparatus of claim 1, wherein the display is a component of or associated with a user computing entity that is operated by or on behalf of a party that is one of (a) an owner of the rail asset, (b) a lessee or sub-lessee of the rail asset, or (c) a party responsible for performing a service of the service event corresponding to the rail asset.

10. The apparatus of claim 1, wherein the electronic communication comprises one or more documents corresponding to an inspection of the rail asset and the at least one memory and the computer program code are further configured to, with the processor, cause the apparatus to at least store the one or more documents in association with a rail asset identifier configured to identify the rail asset.

11. The apparatus of claim 1, wherein the information provided by the electronic communication comprises travel information for the rail asset and at least one memory and the computer program code are further configured to, with the processor, cause the apparatus to at least:
process the travel information for the rail asset;
overwrite content of one or more data fields of the travel information stored in a travel information database;
receive updated travel information for the rail asset; and
update the travel information database based at least in part on the updated travel information, wherein updating the travel information database comprises identifying one or more overwritten data fields of the travel information stored in the travel information database and not updating the one or more overwritten data fields based at least in part on the updated travel information.

12. The apparatus of claim 1, wherein the at least one memory and the computer program code are further configured to, with the processor, cause the apparatus to at least:
store and maintain an asset database storing an asset profiles corresponding to the rail asset; and
update the asset profile to include an indicator of the generated or updated database record.

13. A computer-implemented method comprising:
receiving, by one or more processors, an electronic communication comprising information corresponding to a rail asset;
determining, by the one or more processors, an asset identifier configured to identify the rail asset based at least in part on content of the electronic communication;
determining, by the one or more processors, a category corresponding to the information based at least in part on content of the electronic communication;
identify, by the one or more processors and based at least in part on the category, a database corresponding to the information;
generating or updating, by the one or more processors, a database record stored in the identified database based at least in part on the information and associated with the asset identifier; and
providing, by the one or more processors, an interactive user interface (IUI) configured to enable user interaction with the generated or updated database record, the IUI provided such that display of the IUI is caused via a display.

14. The computer-implemented method of claim 13, wherein the electronic communication comprises a billing repair card document corresponding to at least one service event for the rail asset, the IUI comprises a service event tab configured to provide information regarding one or more service events for the rail asset, and the method further comprises:
determining whether the billing repair card document comprises a service event identifier configured to identify the at least one service event;
responsive to determining that the billing repair card does not comprise the service event identifier:
querying a service event database storing a plurality of service event data objects to identify a service event data object corresponding to the at least one service event based at least in part on at least one of (a) one or more data fields of the billing repair card document or (b) metadata associated with the billing repair card,
extracting the service event identifier from the service event data object, and
associating the service event identifier with the billing repair card document;
cause the service event tab of the IUI to be updated based at least in part on content of the billing repair card document; and
providing the service event tab of the IUI such that the service event tab of the IUI is displayed via the display.

15. The computer-implemented method of claim 14, further comprising:
based at least in part on at least one of lease information or rider information stored in association with the asset, determine whether a lessee of the rail asset should receive rent abatement corresponding to the service event; and
responsive to determining that the lessee of the at least one rail asset should receive rent abatement corresponding to the service event, generate and store an abatement record in association with invoice information associated with the at least one rail asset for a billing cycle corresponding to the service event, wherein the abatement record is generated based at least in part on at least one of (a) a railway asset status associated with the rail asset or (b) an amount of time the rail asset was associated with the railway asset status of in shop.

16. The computer-implemented method of claim 14, further comprising:
determining whether the rail asset is associated with a program of a plurality of programs;
responsive to determining that the rail asset is associated with the program, identifying one or more services corresponding to the program;
determining whether a facility associated with the service event is capable of performing at least one of the one or more services; and
responsive to determining that the facility is capable of performing the at least one of the one or more services, generating and providing a request for the facility to at least one of (a) provide an estimate for performing or (b) perform the at least one of the one or more services.

17. The computer-implemented method of claim 13, wherein the display is a component of or associated with a user computing entity that is operated by or on behalf of a party that is one of (a) an owner of the rail asset, (b) a lessee or sub-lessee of the rail asset, or (c) a party responsible for performing a service of the service event corresponding to the rail asset.

18. The computer-implemented method of claim 13, wherein the electronic communication comprises one or more documents corresponding to an inspection of the rail asset and the at least one memory and the computer program code are further configured to, with the processor, cause the apparatus to at least store the one or more documents in association with a rail asset identifier configured to identify the rail asset.

19. The computer-implemented method of claim 13, wherein the information provided by the electronic communication comprises travel information for the rail asset and the method further comprises:
processing the travel information for the rail asset;
overwriting content of one or more data fields of the travel information stored in a travel information database;
receiving updated travel information for the rail asset; and
updating the travel information database based at least in part on the updated travel information, wherein updating the travel information database comprises identifying one or more overwritten data fields of the travel information stored in the travel information database and not updating the one or more overwritten data fields based at least in part on the updated travel information.

20. The computer-implemented method of claim 13, further comprising:
storing and maintain an asset database storing an asset profiles corresponding to the rail asset; and
updating the asset profile to include an indicator of the generated or updated database record.

21. A computer program product comprising at least one non-transitory computer-readable storage medium having computer-readable program code portions stored therein, the computer-readable program code portions configured, when executed by one or more processors, to:
receive an electronic communication comprising information corresponding to a rail asset;
determine an asset identifier configured to identify the rail asset based at least in part on content of the electronic communication;
determine a category corresponding to the information based at least in part on content of the electronic communication;
identify, based at least in part on the category, a database corresponding to the information;
generate or update a database record stored in the identified database based at least in part on the information and associated with the asset identifier; and
provide an interactive user interface (IUI) configured to enable user interaction with the generated or updated database record, the IUI provided such that display of the IUI is caused via a display.
